(19) United States
(12) Patent Application Publication
(10) Pub. No.: US 2026/0000008 A1
(43) Pub. Date: Jan. 1, 2026

(54) TRAVEL CONTROL SYSTEM, WORK VEHICLE, AND METHOD OF TRAVEL CONTROL

(71) Applicant: Kubota Corporation, Osaka (JP)

(72) Inventors: Shogo HAYASHIDA, Sakai-shi (JP); Tomohiro KINOSHITA, Sakai-shi (JP); Kazuo YOSHIKAWA, Sakai-shi (JP)

(21) Appl. No.: 19/248,531

(22) Filed: Jun. 25, 2025

(30) Foreign Application Priority Data
Jun. 27, 2024 (JP) 2024-104466

(51) Int. Cl. A01B 79/00; A01B 59/043; A01B 69/04; A01B 71/06; G05D 1/229; G05D 107/20

(52) U.S. Cl. CPC A01B 79/005; A01B 59/043; A01B 69/008; A01B 71/066; G05D 1/2297; G05D 2107/21

(57) ABSTRACT

A travel control system for a work vehicle includes a positioning device to output position data of the work vehicle, a sensor to detect a state of the work vehicle and output sensor data, and a controller. In a recording mode, while the work vehicle is traveling, the controller is configured or programmed to record waypoint information including information concerning a position and the state of the work vehicle. In a reproducing mode, the controller is configured or programmed to control operation of the work vehicle during self-traveling based on the waypoint information recorded in the recording mode. In response to a user operation while in the recording mode to make an alteration to the state of the work vehicle to produce an altered state, the alteration that is based on the user operation is restricted when the altered state is unsuitable for recording of the waypoint information.

### CROSS REFERENCE TO RELATED APPLICATIONS

This application claims the benefit of priority to Japanese Patent Application No. 2024-104466 filed on Jun. 27, 2024. The entire contents of this application are hereby incorporated herein by reference.

### BACKGROUND OF THE INVENTION

### 1. Field of the Invention

The present disclosure relates to travel control systems, work vehicles, and methods of travel control.

### 2. Description of the Related Art

As attempts in next-generation agriculture, research and development of smart agriculture utilizing ICT (Information and Communication Technology) and IoT (Internet of Things) is under way. Research and development is also directed to the automation and unmanned use of tractors or other work vehicles to be used in the field. For example, work vehicles which travel via automatic steering by utilizing a positioning system that is capable of precise positioning, e.g., a GNSS (Global Navigation Satellite System), are coming into practical use.

International Publication No. 2022/107586 describes a work vehicle that is capable of autonomous movement among a plurality of rows of trees in an orchard, such as a vineyard, by using an SLAM (Simultaneous Localization and Mapping) technique that simultaneously performs localization and map generation. International Publication No. 2022/107586 describes, in an orchard, a work vehicle traveling among a plurality of rows of trees, where the work vehicle performs mowing, preventive pest control, or other work by using an implement (agricultural implement) that is linked to the work vehicle.

### SUMMARY OF THE INVENTION

There is also a need for automation and unmanned application of work that is performed while a work vehicle travels in a field (e.g., an orchard). Work that is performed during the travel of a work vehicle in a field may involve the same task being iteratively performed multiple times. For example, tasks such as mowing and preventive pest control may be iteratively performed multiple times for the same field. When the same task is iteratively performed, the work vehicle performs the same task while traveling along the same path in the field in the same way. In such a case, performing every instance of autonomous travel by, e.g., an SLAM technique will lead to an unwanted increase in the processing load for the autonomous travel.

Efficiently performing iterative operations of a work vehicle is required not only in agricultural machines, but also in work vehicles that are for non-agricultural uses, such as construction vehicles or snowplow vehicles. Furthermore, even in the cases of travel that does not involve work of a work vehicle, it is necessary to efficiently carry out any travel that is performed iteratively along the same path.

Example embodiments of the present disclosure provide travel control systems, work vehicles, and methods of travel control that enable efficient performance of iterative operations (including travel and other operations) of a work vehicle.

According to an example embodiment of the present disclosure, a travel control system for a work vehicle includes a positioning device to detect a position of the work vehicle and output position data, one or more sensors to detect a state of the work vehicle and output sensor data, and a controller configured or programmed to control operation of the work vehicle, operate in a recording mode and a reproducing mode, in the recording mode, record to a storage device multiple pieces of waypoint information based on the position data and the sensor data while the work vehicle is traveling, each of the multiple pieces of waypoint information including first information concerning the position of the work vehicle and second information concerning the state of the work vehicle, in the reproducing mode, control the operation of the work vehicle while causing the work vehicle to travel via self-driving based on the first information and the second information included in the multiple pieces of waypoint information recorded in the recording mode, and in response to a user operation while in the recording mode to make an alteration to the state of the work vehicle to produce an altered state, restrict the alteration that is based on the user operation when the altered state is unsuitable for recording of the multiple pieces of waypoint information.

According to an example embodiment of the present disclosure, a work vehicle includes a travel control system according to an example embodiment of the present disclosure, a travel device including wheels responsible for steering, and a first driver to drive the travel device, wherein in the reproducing mode, the controller is configured or programmed to cause the work vehicle to travel via self-driving by controlling the first driver based on the first information and the second information included in the multiple pieces of waypoint information recorded in the recording mode.

According to an example embodiment of the present disclosure, a method of travel control for a work vehicle to be performed by a controller configured or programmed to control operation of a work vehicle and operate in a recording mode and a reproducing mode, includes, in the recording mode, while the work vehicle is traveling, recording to a storage device multiple pieces of waypoint information based on position data acquired from a positioning device to detect a position of the work vehicle and sensor data acquired from one or more sensors to detect a state of the work vehicle, each of the multiple pieces of waypoint information including first information concerning the position of the work vehicle and second information concerning the state of the work vehicle, in the reproducing mode, controlling the operation of the work vehicle while causing the work vehicle to travel via self-driving based on the first information and the second information included in the multiple pieces of waypoint information recorded in the recording mode, and in response to a user operation while in the recording mode to make an alteration to the state of the work vehicle to produce an altered state, restricting the alteration that is based on the user operation when the altered state is unsuitable for recording of the multiple pieces of waypoint information.

Example embodiments of the present disclosure may be implemented using a device, a system, a method, an integrated circuit, a computer program, a computer-readable storage medium, or any combination thereof. The computer-readable storage medium may be inclusive of a volatile storage medium, or a non-volatile storage medium. The device may include a plurality of devices. In the case where the device includes two or more devices, the two or more devices may be provided within a single apparatus, or divided over two or more separate apparatuses.

According to example embodiments of the present disclosure, travel control systems, work vehicles, and methods of travel control that enable efficient performance of iterative operations (including travel and other operations) of work vehicles are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically showing an example of a work vehicle according to an example embodiment of the present disclosure.

FIG. 2 is a block diagram schematically showing an example configuration for a work vehicle and an implement according to an example embodiment of the present disclosure.

FIG. 3A is a block diagram showing a schematic example configuration for a travel control system according to an example embodiment of the present disclosure.

FIG. 3B is a block diagram showing an example configuration for a controller included in a travel control system according to an example embodiment of the present disclosure.

FIG. 4 is a schematic diagram showing an example configuration for a travel control system according to an example embodiment of the present disclosure.

FIG. 5 is a diagram schematically showing an example environment to be traveled by a work vehicle according to an example embodiment of the present disclosure.

FIG. 6A is a diagram schematically showing an example of a path to be traveled by a work vehicle according to an example embodiment of the present disclosure in a recording mode.

FIG. 6B is a diagram schematically showing an example of a path to be traveled by a work vehicle according to an example embodiment of the present disclosure in a reproducing mode.

FIG. 7 is a diagram schematically showing another example of a path to be traveled by a work vehicle according to an example embodiment of the present disclosure.

FIG. 8 is a diagram schematically showing another example of a path to be traveled by a work vehicle according to an example embodiment of the present disclosure.

FIG. 9A is a flowchart showing an example processing to be performed by the controller in the recording mode.

FIG. 9B is a flowchart showing another example processing to be performed by the controller in the recording mode.

FIG. 9C is a flowchart showing still another example processing to be performed by the controller in the recording mode

FIG. 10 is a diagram showing an example of waypoint information.

FIG. 11 is a flowchart showing an example processing to be performed by the controller in the reproducing mode.

FIG. 12A is a diagram schematically showing an example processing to be performed by a controller of a travel control system according to an example embodiment of the present disclosure.

FIG. 12B is a diagram schematically showing an example processing to be performed by a controller of a travel control system according to an example embodiment of the present disclosure.

FIG. 12C is a diagram schematically showing an example processing to be performed by a controller of a travel control system according to an example embodiment of the present disclosure.

FIG. 13 is a diagram showing an example of operation switches and an operation terminal provided in a cabin that is included in a work vehicle.

FIG. 14 is a flowchart showing an example processing to be performed by the controller in the recording mode.

FIG. 15 is a flowchart showing an example processing to be performed by the controller when a signal including an instruction to begin the recording mode is received.

FIG. 16 is a schematic diagram for describing an example processing to be performed by the controller.

FIG. 17 is a diagram showing an example of braking operation devices provided inside the cabin of the work vehicle.

FIG. 18 is a flowchart showing an example processing to be performed by the controller when a user has performed an operation to alter the state of the work vehicle in the recording mode.

FIG. 19A is a flowchart showing an example processing to be performed by the controller when a user has performed an operation to alter the state of the work vehicle in the recording mode.

FIG. 19B is a flowchart showing an example processing to be performed by the controller when a user has performed an operation to alter the state of the work vehicle in the recording mode.

FIG. 19C is a flowchart showing an example processing to be performed by the controller when a user has performed an operation to alter the state of the work vehicle in the recording mode.

### DETAILED DESCRIPTION OF THE EXAMPLE EMBODIMENTS

In the present disclosure, a “work vehicle” includes a vehicle for use in performing work in a work area. A “work area” is any place where work may be performed, e.g., a field, a mountain forest, or a construction site. A “field” is any place where agricultural work may be performed, e.g., an orchard, an agricultural field, a paddy field, a cereal farm, or a pasture. A work vehicle can be an agricultural machine such as a tractor, a rice transplanter, a combine, a vehicle for crop management, or a riding mower, or a vehicle for non-agricultural purposes such as a construction vehicle or a snowplow vehicle. A work vehicle may be configured so that an implement (also referred to as a “task device” or a “task apparatus”) that is suitable for the content of work can be attached to at least one of its front and its rear. In particular, an implement that is attached to an agricultural tractor may be referred to as an “agricultural implement”. Traveling of a work vehicle that is made while it performs work by using an implement may be referred to as “tasked travel”. The “operation” of a work vehicle includes not only travel of the work vehicle but also other operations.

“Self-driving” includes controlling the travel of a vehicle based on the action of a controller, rather than through manual operation of a driver. During self-driving, not only the travel of the vehicle, but also the task operation (e.g., the operation of the implement) may also be automatically controlled. A vehicle that is traveling via self-driving is said to be “self-traveling”. The controller may be configured or programmed to control at least one of steering, adjustment of traveling speed, or starting and stopping of travel as are necessary for the travel of vehicle. In the case of controlling a work vehicle having an implement attached thereto, the controller may be configured or programmed to control operations such as raising or lowering of the implement, starting and stopping of the operation of the implement, and the like. Travel via self-driving includes not only the travel of a vehicle toward a destination along a predetermined path, but also the travel of merely following a target of tracking. A vehicle performing self-driving may operate not only in a self-driving mode but also in a manual driving mode of traveling through manual operation of the driver. Traveling through manual operation of the driver is referred to as “manual traveling”. “Manual operation of a driver” includes not only manual operation by a driver on the vehicle, but also remote operation by a driver (operator) outside the vehicle. A vehicle performing self-driving may travel partly based on manual operation of the driver. The steering of a vehicle that is based on the action of a controller, rather than manual operation of the driver, is referred to as “automatic steering”. A portion or a whole of the controller may be external to the vehicle. Between the vehicle and a controller that is external to the vehicle, communication of control signals, commands, data, or the like may be performed. A vehicle performing self-driving may autonomously travel while sensing the surrounding environment, without any person being involved in the control of the travel of the vehicle. A vehicle that is capable of autonomous travel can travel in an unmanned manner. During autonomous travel, detection of obstacles and avoidance of obstacles may be performed.

A “crop row” is a row of agricultural items, trees, or other plants that may grow in rows on a field, e.g., an orchard or an agricultural field, or in a forest or the like. In the present disclosure, a “crop row” is a notion that encompasses a “row of trees”.

Hereinafter, example embodiments of the present disclosure will be

described more specifically. Note however that unnecessarily detailed descriptions may be omitted. For example, detailed descriptions of what is well known in the art or redundant descriptions of what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only examples, and the techniques according to example embodiments of the present disclosure are not limited to the following example embodiments. For example, numerical values, shapes, materials, steps, orders of steps, etc., that are indicated in the following example embodiments are only examples, and admit of various modifications so long as it makes technological sense. Any one implementation may be combined with another.

Hereinafter, as one example, an example embodiment where the work vehicle is a tractor for use in agricultural work in a field such as an orchard will be described. Without being limited to tractors, the techniques according to example embodiments of the present disclosure are also applicable to other type of agricultural machines such as a rice transplanter, a combine, a vehicle for crop management, or a riding lawn mower, for example. The techniques according to example embodiments of the present disclosure is also applicable to vehicles for non-agricultural purposes such as a construction vehicle or a snowplow vehicle. Furthermore, the techniques according to example embodiments of the present disclosure are applicable to travel of a work vehicle other than in work areas, and also to travel of the work vehicle that does not involve any work.

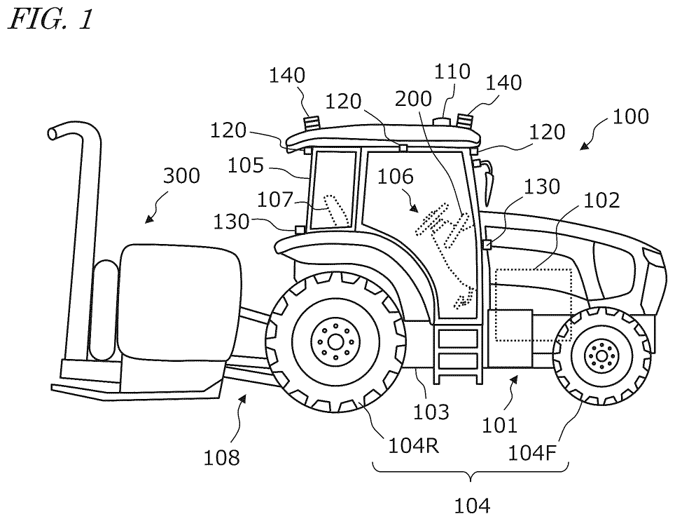

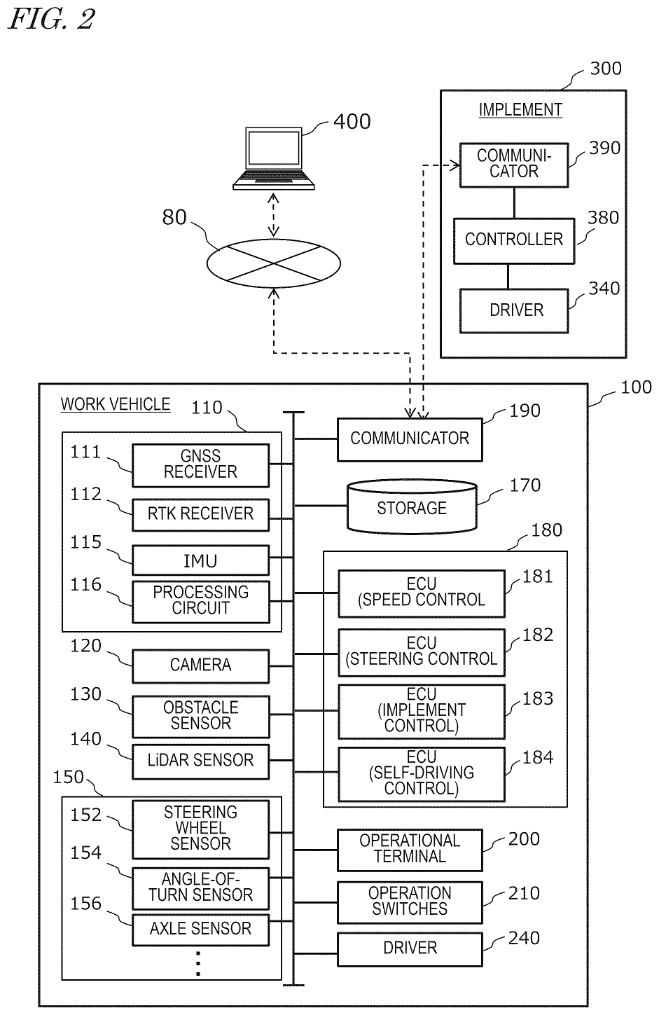

FIG. 1 is a side view schematically showing an example of a work vehicle 100 and an implement 300 that is linked to the work vehicle 100. FIG. 2 is a block diagram schematically showing an example configuration for the work vehicle 100 and the implement 300.

As shown in in FIG. 1 and FIG. 2, the work vehicle 100 includes a positioning device 110 to detect the position of the work vehicle 100 and output position data (e.g., a GNSS unit), a sensor group 150 to detect the state of the work vehicle 100 and output sensor data, and a controller 180 configured or programmed to control the operation of the work vehicle 100. The sensor group 150 includes one or more sensors.

The work vehicle 100 may further include a plurality of external sensors to sense the surroundings of the work vehicle 100. An “external sensor” is a sensor that senses the external state of the work vehicle. In the example of FIG. 1, the external sensors include a plurality of LiDAR sensors 140, a plurality of cameras 120, and a plurality of obstacle sensors 130.

In addition to the positioning device 110, the cameras 120, the obstacle sensors 130, the LiDAR sensors 140, the sensor group 150, a storage device 170, the controller 180, and an operation terminal 200, the work vehicle 100 in the example of FIG. 2 also includes a communicator 190, operation switches 210, and a driver 240 (which may be referred to as a “first driver”). These component elements are communicably connected to one another via a bus.

As shown in FIG. 1, the work vehicle 100 includes a vehicle body 101, a prime mover (engine) 102, and a transmission 103. On the vehicle body 101, a travel device, which includes wheels 104 with tires, and a cabin 105 are provided. The travel device includes four wheels 104, and axles to cause the four wheels to rotate, and braking device (brakes) to brake on each axle. The wheels 104 include a pair of front wheels 104F and a pair of rear wheels 104R. Inside the cabin 105, a driver's seat 107, a steering device 106, an operation terminal 200, and switches for operation are provided. The front wheels 104F and/or the rear wheels 104R may be replaced by a plurality of wheels with a track (crawlers), rather than wheels with tires, attached thereto.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by operating the steering wheel. The power steering device includes a hydraulic device or an electric motor to supply an assisting force to change the steering angle of the front wheels 104F. When automatic steering is performed, under the control of the controller in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point hitch” or a “three-point link”), a PTO (Power Take Off) shaft, a universal joint, and a communication cable. The linkage device 108 allows the implement 300 to be attached to, or detached from, the work vehicle 100. The linkage device 108 is able to raise or lower the three-point hitch with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 1 is a sprayer to spray a chemical agent onto a crop, the implement 300 is not limited to a sprayer. For example, any arbitrary implement such as a mower, a seeder, a spreader, a rake, a baler, a harvester, a plow, a harrow, or a rotary tiller may be connected to the work vehicle 100 for use.

The positioning device 110 receives satellite signals (also referred to as GNSS signals) that are transmitted from a plurality of GNSS satellites, and performs positioning based on the satellite signals. GNSS is a collective term for satellite positioning systems such as the GPS (Global Positioning System), QZSS (Quasi-Zenith Satellite System, e.g., MICHIBIKI), GLONASS, Galileo, and BeiDou. Although the positioning device 110 in the present example embodiment is located above the cabin 105, it may be located at any other position.

As shown in FIG. 2, the positioning device 110 includes a GNSS receiver

111, an RTK receiver 112, and a processing circuit 116. The positioning device 110 may further include an inertial measurement unit (IMU) 115.

The GNSS receiver 111 includes an antenna to receive signals from the GNSS satellites, and a processing circuit to determine the position of the work vehicle 100 based on the signals received by the antenna. The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received.

The positioning device 110 may perform positioning of the work vehicle 100 by utilizing an RTK (Real Time Kinematic)-GNSS. In the positioning based on the RTK-GNSS, not only satellite signals transmitted from a plurality of GNSS satellites, but also a correction signal that is transmitted from a reference station is used. The reference station may be disposed near the work area where the work vehicle 100 performs tasked travel (e.g., at a position within 10 km of the work vehicle 100). The reference station generates a correction signal of, for example, an RTCM format based on the satellite signals received from the plurality of GNSS satellites, and transmits the correction signal to the positioning device 110. The RTK receiver 112, which includes an antenna and a modem, receives the correction signal transmitted from the reference station. Based on the correction signal, the processing circuit 116 of the positioning device 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The positioning device 110 calculates the position of the work vehicle 100 as frequently as, for example, one to ten times per second. Note that the positioning method is not limited to being performed by using an RTK-GNSS, any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The positioning device 110 according to the present example embodiment may further include the IMU 115. With the inclusion of the IMU 115, the positioning device 110 can complement position data by utilizing signals from the IMU 115. The data acquired by the IMU 115 can be used to complement the position data based on the satellite signals, so as to improve the performance of positioning.

The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. For example, the IMU 115 outputs a signal as frequently as approximately several ten times to several thousand times per second. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

The sensor group 150 may include various sensors to detect the state of the work vehicle 100 or the implement 300 (i.e., internal sensors). For example, the sensor group 150 may include a steering wheel sensor 152, an angle-of-turn sensor 154, and an axle sensor 156.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 may be used for steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100. Measurement values from the axle sensor 156 can be utilized for the speed control by the controller 180.

The storage device 170 includes one or more storage media such as a flash memory or a magnetic disc. The storage device 170 stores various data that is generated by the positioning device 110, the cameras 120, the obstacle sensors 130, the LiDAR sensors 140, the sensor group 150, and the controller 180. The data that is stored by the storage device 170 may include an environment map of the environment where the work vehicle 100 travels, an obstacle map that is consecutively generated during travel, and path data for self-driving. The storage device 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 is configured or programmed to include the plurality of ECUs. The plurality of ECUs include, for example, the ECU 181 for speed control, the ECU 182 for steering control, the ECU 183 for implement control, and the ECU 184 for self-driving control.

The ECU 181 controls the prime mover 102, the transmission 103, and brakes included in the driver 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point hitch, the PTO shaft, and the like that are included in the linkage device 108. Also, the ECU 183 generates a signal to control the operation of the implement 300, and transmits this signal from the communicator 190 to the implement 300.

Based on data output from the positioning device 110, the cameras 120, the obstacle sensors 130, the LiDAR sensors 140, and the sensor group 150, the ECU 184 performs computation and control for achieving self-driving. For example, the ECU 184 estimates the position of the work vehicle 100 based on the data output from at least one of the positioning device 110, the cameras 120, or the LiDAR sensors 140. In a situation where a sufficiently high reception intensity exists for the satellite signals from the GNSS satellites, the ECU 184 may determine the position of the work vehicle 100 based only on the data output from the positioning device 110. On the other hand, in an environment where obstructions, such as trees, that may hinder reception of the satellite signals exist around the work vehicle 100, e.g., an orchard, the ECU 184 estimates the position of the work vehicle 100 by using the data output from the LiDAR sensors 140 or the cameras 120. During self-driving, the ECU 184 performs computation necessary for the work vehicle 100 to travel along a target path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103, or the brakes to change the speed of the work vehicle 100. In response to the command to change the steering angle, the ECU 182 controls the steering device 106 to change the steering angle.

Through the actions of these ECUs, the controller 180 realizes self-traveling. During self-traveling, the controller 180 is configured or programmed to control the driver 240 based on the measured or estimated position of the work vehicle 100 and on the consecutively-generated target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 184 are illustrated as individual blocks in FIG. 2, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes a processing circuit including one or more processors.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device, which is responsible for remote monitoring, for example. The images may be used to monitor the work vehicle 100 during unmanned driving. The cameras 120 may be provided according to the needs, and any number of them may be provided.

The LiDAR sensors 140 are one example of external sensors that output sensor data indicating a distribution of geographic features around the work vehicle 100. In the example of FIG. 1, two LiDAR sensors 140 are provided on the cabin 105, at the front and the rear. The LiDAR sensors 140 may be provided at other positions (e.g., on a lower portion of a front face of the vehicle body 101). While the work vehicle 100 is traveling, each LiDAR sensor 140 repeatedly outputs sensor data representing the distances and directions of measurement points on objects existing in the surrounding environment, or two-dimensional or three-dimensional coordinate values of such measurement points. The number of LiDAR sensors 140 is not limited to two, but may be one, or three or more.

The LiDAR sensors 140 may be configured to output two-dimensional or three-dimensional point cloud data as sensor data. In the present specification, “point cloud data” broadly includes data indicating a distribution of multiple reflection points that are observed with the LiDAR sensors 140. The point cloud data may include coordinate values of each reflection point in a two-dimensional space or a three-dimensional space or information indicating the distance and direction of each reflection point, for example. The point cloud data may include information of luminance of each reflection point. The LIDAR sensors 140 may be configured to repeatedly output point cloud data with a pre-designated cycle, for example. Thus, the external sensors may include one or more LiDAR sensors 140 that output point cloud data as sensor data.

The sensor data that is output from the LiDAR sensors 140 is processed by a controller configured or programmed to control self-traveling of the work vehicle 100. During travel of the work vehicle 100, based on the sensor data that is output from the LIDAR sensors 140, the controller can consecutively generate an obstacle map indicating a distribution of objects existing around the work vehicle 100. The controller may generate an environment map by joining together obstacle maps with the use of an algorithm such as SLAM, for example, during self-traveling. The controller can perform estimation of the position and orientation of the work vehicle 100 (i.e., localization) by matching the sensor data against the environment map.

The plurality of obstacle sensors 130 shown in FIG. 1 are provided at the front and the rear of the cabin 105. The obstacle sensors 130 may be provided at other positions. For example, one or more obstacle sensors 130 may be provided at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles.

The controller of the work vehicle 100 may utilize, for positioning, the sensor data acquired with the sensing devices such as the cameras 120 or the LIDAR sensors 140, in addition to the results of positioning provided by the positioning device 110. In the case where geographic features serving as characteristic points exist in the environment that is traveled by the work vehicle 100, as in the case of an agricultural road, a forest road, a general road, or an orchard, the position and the orientation of the work vehicle 100 can be estimated with a high accuracy based on data that is acquired with the cameras 120 or the LiDAR sensors 140 and on an environment map that is previously stored in the storage device. By correcting or complementing position data based on the satellite signals using the data acquired with the cameras 120 or the LiDAR sensors 140, it becomes possible to identify the position of the work vehicle 100 with a higher accuracy.

The work vehicle 100 and the implement 300 can communicate with each other via a communication cable that is included in the linkage device 108. The work vehicle 100 is able to communicate with a terminal device 400 for remote monitoring via a network 80. The terminal device 400 may be any arbitrary computer, e.g., a personal computer (PC), a laptop computer, a tablet computer, or a smartphone, for example.

The implement 300 includes a driver 340 (which may be referred to as the “second driver”), a driver 340, a controller 380, and a communicator 390. Note that FIG. 2 shows component elements which are relatively closely related to the operations of self-driving by the work vehicle 100, while other components are omitted from illustration.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 1, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as a camera(s) to generate images for monitoring purposes. The infrared camera(s) may also be used for detection of obstacles at nighttime.

An obstacle sensor 130 detects objects around the work vehicle 100. The obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be disposed at different positions of the work vehicle 100. Providing a multitude of obstacle sensors 130 can reduce blind spots in monitoring obstacles around the work vehicle 100.

The driver 240 includes various types of devices required to cause the work vehicle 100 to travel and to drive the implement 300. For example, the prime mover 102, the transmission 103, the steering device 106, the linkage device 108 and the like described above. The prime mover 102 may include an internal combustion engine such as, for example, a diesel engine. The driver 240 may include an electric motor for traction instead of, or in addition to, the internal combustion engine.

The communicator 190 includes a circuit communicating with the implement 300 and the terminal device 400. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with the terminal device 400. The network 80 may include a 3G, 4G, 5G, or any other cellular mobile communications network and the Internet, for example. The communicator 190 may have a function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operation terminal 200 is a terminal for the user to perform an operation related to the travel of the work vehicle 100 and the operation of the implement 300, and is also referred to as a virtual terminal (VT). The operation terminal 200 may include a display device such as a touch screen panel, and/or one or more buttons. The display device may be a display such as a liquid crystal display or an organic light-emitting diode (OLED) display, for example. By operating the operation terminal 200, the user can perform various operations, such as, for example, switching ON/OFF the self-driving mode, switching ON/OFF a recording (teaching) mode and a reproducing (playback) mode as will be described below/, and switching ON/OFF the implement 300. At least a portion of these operations may also be realized by operating the operation switches 210. The operation terminal 200 may be configured so as to be detachable from the work vehicle 100. A user who is at a remote place from the work vehicle 100 may operate the detached operation terminal 200 to control the operation of the work vehicle 100. The operation terminal 200 may include a storage device. In place of the storage device 170, the storage device in the operation terminal 200 may store various data that is necessary for the operation of the work vehicle 100. The driver 340 in the implement 300 shown in FIG. 2 performs necessary operations for the implement 300 to perform predetermined tasks. The driver 340 includes a device that is adapted to the use of the implement 300, e.g., a hydraulic device, an electric motor, or a pump. The controller 380 is configured or programmed to control the operation of the driver 340. In response to signals that are transmitted from the work vehicle 100 via the communicator 390, the controller 380 causes the driver 340 to perform various operations. Moreover, a signal that is in accordance with the state of the implement 300 may be transmitted from the communicator 390 to the work vehicle 100.

Travel control systems according to example embodiments of the present disclosure will be described. Travel control system according to the example embodiments of the present disclosure are applicable to the above-described work vehicle 100, for example. Although the examples of FIG. 1 and FIG. 2 illustrate the implement 300 as being linked to the work vehicle 100, it is not essentially required for the implement 300 to be linked to the work vehicle 100. In other words, the travel control systems according to the example embodiments of the present disclosure are applicable also to the work vehicle 100 without the implement 300 linked thereto.

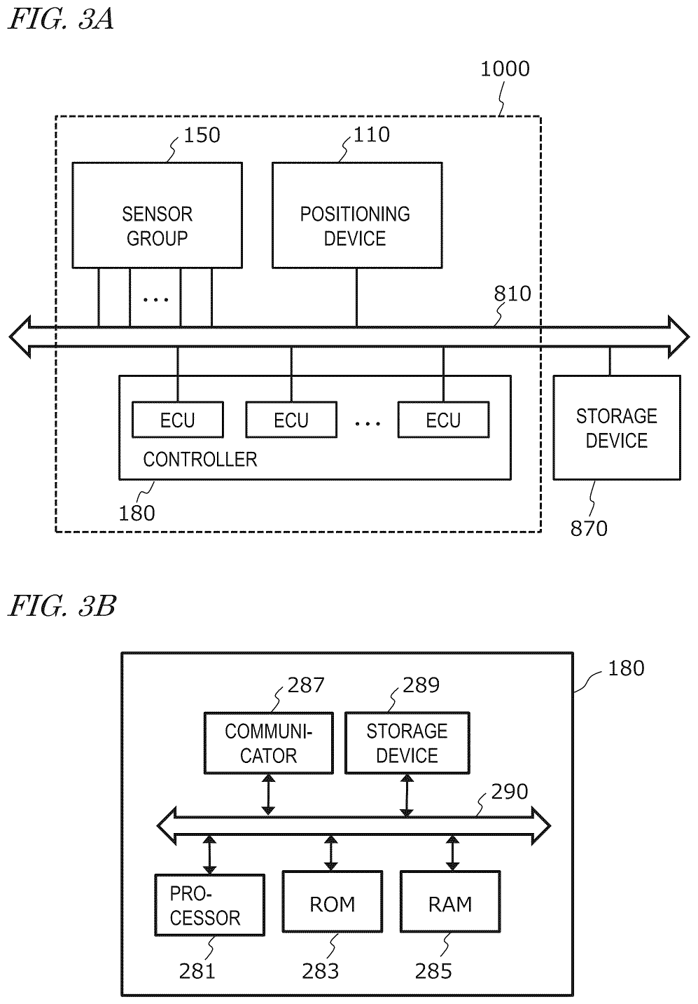

FIG. 3A is a block diagram showing a schematic example configuration for the travel control system 1000 according to an example embodiment of the present disclosure. As shown in FIG. 3A, the travel control system 1000 according to the present example embodiment includes a positioning device 110 to detect the position of the work vehicle 100 and output position data, one or more sensors (sensor group) 150 to detect the state of the work vehicle 100 and output sensor data, and a controller 180 configured or programmed to control the operation of the work vehicle 100. In the present example embodiment, as shown in FIG. 2, the positioning device 110, the sensor group 150, and the controller 180 are provided in the work vehicle 100. Working in cooperation with the positioning device 110 and the sensor group 150, the controller 180 is configured or programmed to function as the travel control system 1000 of the work vehicle 100. The controller 180, the positioning device 110, and the sensor group 150 may be communicably connected to one another via a bus 810.

FIG. 3A also shows a storage device 870, to which information that is acquired by the controller 180 is recorded. The storage device 870 may be included in the control system 1000, or be an external element to the control system 1000. The storage device 870 may be mounted in the work vehicle 100, or mounted in the implement 300. The storage device 870 may be communicably connected to the controller 180 via the 810. For example, the storage device 870 may be the storage device 170 shown in FIG. 2, or a storage device that is included in the operation terminal 200. The operation terminal 200 may be included in the travel control system 1000. The storage device 870 may be located outside of the work vehicle 100 and the implement 300. When located outside of the work vehicle 100 and the implement 300, the storage device 870 may be connected to the controller 180 via a communications network.

In the example shown in FIG. 1, the positioning device 110 is mounted to the work vehicle 100. However, the positioning device 110 may be mounted to the implement 300 that is linked to the work vehicle 100. In addition to or instead of the positioning device mounted to the work vehicle 100, a positioning device (e.g., a GNSS unit) that is mounted to the implement 300 may function as a positioning device 110 of the travel control system 1000. Strictly speaking, a position that is measured by a positioning device that is mounted to the work vehicle 100 or the implement 300 is the position of a point at which the positioning device exists, but this position is referred to as the “position of the work vehicle” in the present specification.

Without being limited to the steering wheel sensor 152, the angle-of-turn sensor 154, and the axle sensor 156 mentioned above, various sensors that are mounted in the work vehicle 100 may be included in the sensor group 150. For example, the sensor group 150 may include one or more sensors selected from among a temperature sensor, an illuminance sensor, a fuel sensor, a water temperature sensor, an oil level gauge, an engine speed sensor, a vehicle speed sensor, a battery voltage sensor, a shuttle sensor, a hand accelerator sensor, an accelerator pedal sensor, a main shift lever sensor, a range shift lever sensor, a seat belt sensor, a PM sensor, an acceleration sensor, an angular velocity sensor, an IMU (Inertial Measurement Unit), and a geomagnetic sensor. The sensor group 150 may include a PTO sensor to detect rotation ON/OFF of the PTO shaft and/or a 3P position sensor to detect the position in the height direction (which hereinafter may be simply referred to as “height”) of the three-point hitch. Furthermore, in addition to or instead of one or more sensors mounted on the work vehicle 100, one or more sensors that are mounted on the implement 300 may be included in the sensor group 150 of the travel control system 1000.

In the example shown in FIG. 3A, the controller 180 is configured or programmed to include a plurality of ECUs. These ECUs may include the ECUs 181 to 184 illustrated in FIG. 2, for example. However, the controller 180 may be a single ECU or other computing device. FIG. 3B is a block diagram showing an example configuration for such a controller 180. In the example of FIG. 3B, the controller 180 includes a processor 281, a ROM (Read Only Memory) 283, a RAM (Random Access Memory) 285, a communicator 287, and a storage device 289. These component elements may be connected to one another via a bus 290.

The processor 281 may include a semiconductor integrated circuit, also called a central processing unit (CPU) or a microprocessor. The processor 281 may include a graphics processing unit (GPU). The processor 281 consecutively executes a computer program describing predetermined instructions and being stored in the ROM 283, and achieves processes that are necessary for the travel control system according to the present disclosure. The controller 180 may include a plurality of processors 281. The plurality of processors 281 may work in cooperation to perform the processes that are necessary for the travel control system according to the present disclosure. A portion or a whole of the processor 281 may be an FPGA (Field Programmable Gate Array), an ASIC (Application Specific Integrated Circuit), or an ASSP (Application Specific Standard Product) incorporating a CPU.

The communicator 287 is an interface configured or programmed to perform data communications between the controller 180 and an external computing device. The communicator 287 is capable of wired communications via a CAN (Controller Area Network) or the like, or wireless communications compliant with the Bluetooth (registered trademark) standards and/or the Wi-Fi (registered trademark) standards.

The storage device 289 can store position data acquired from the positioning device 110, sensor data acquired from the sensor group 150, position data and/or sensor data in the middle of processing, data of first information acquired from the position data and second information acquired from the sensor data, and the like. The storage device 289 includes a hard disk drive or a non-volatile semiconductor memory, for example. In this example, the storage device 289 may serve as the storage device 870 in the example of FIG. 3A.

The hardware configuration of the controller 180 is not limited to the above example. It is not necessary for a portion or a whole of the controller 180 to be mounted in the work vehicle 100. By utilizing the communicator 287, a computing device or computing devices located outside the work vehicle 100 may be allowed to function as a portion or a whole of the controller 180. For example, a computing device or computing devices included in a server computer(s) and/or a terminal device(s) that is connected to a network may function as a portion or a whole of the controller 180. On the other hand, a computing device or computing devices that is mounted in the work vehicle 100 may perform all functions required of the controller 180.

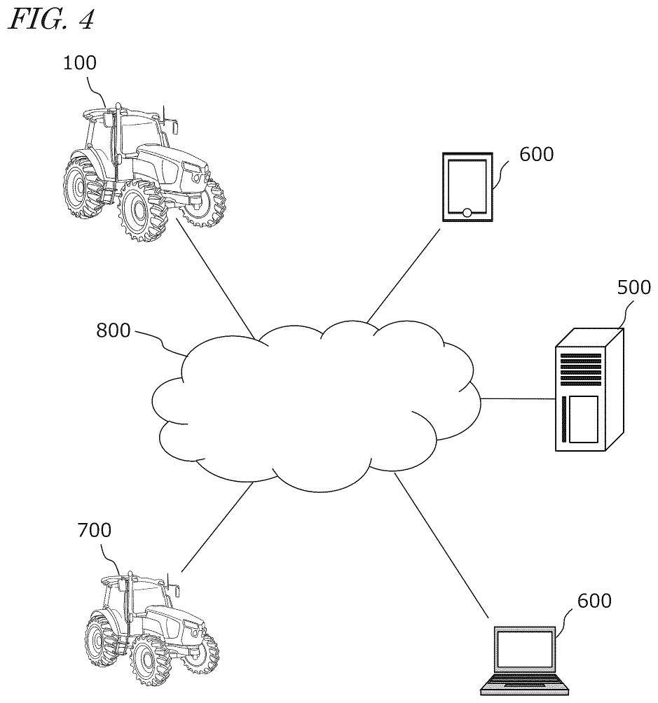

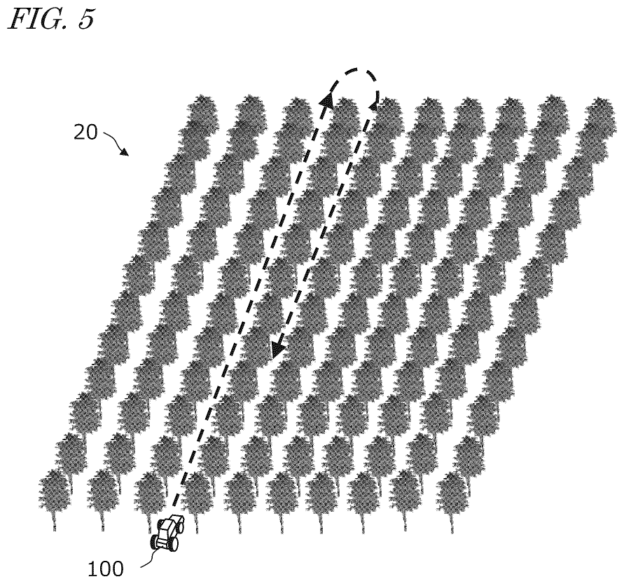

FIG. 4 is a schematic diagram showing another example configuration for a travel control system according to an example embodiment of the present disclosure. The system shown in FIG. 4 includes the work vehicle 100, another work vehicle 700, a server computer 500, and a plurality of terminal devices 600. The terminal devices 600 may be either mobile or stationary terminal devices. A portion or a whole of the functionality of the controller 180 shown in FIG. 3B may be realized by one or more computing devices that are connected to the communicator 287 of the controller 180 of the work vehicle 100 via a communications network 800. Such a computing device(s) may be the server computer 500 or the terminal device(s) 600. This communications network 800 may have the other work vehicle (e.g., agricultural machine) 700 connected thereto. Communication may be performed between the controller 180 of the work vehicle 100 and the other work vehicle 700. Via the communications network 800, a portion of the data to be used for the processing by the controller 180 of the work vehicle 100 may be supplied from the other work vehicle 700 to the controller 180. For example, waypoint information defining a path and a series of operations as generated by the controller of the other work vehicle 700 may be transmitted from the other work vehicle 700 to the controller 180 of the work vehicle 100. Based on the waypoint information, the controller 180 can perform a playback operation in a reproducing mode as will be described below.

As shown in FIG. 3B, an example of the “controller” according to an example embodiment of the present disclosure is a computing device that includes at least one processor and at least one memory storing a computer program (code) defining control processes to be executed by the processor. The “controller” may be a computing device including an FPGA (Field-Programmable Gate Array), an ASSP (Application Specific Standard Product), an ASIC (Application-Specific Integrated Circuit), or other hardware accelerators configured to execute the control processes.

A “processor” in the present disclosure is a hardware electronic circuit such as a CPU (Central Processing Unit), a GPU (Graphics Processing Unit), a DSP (Digital Signal Processor), an ISP (Image Signal Processor), or an NPU (Neural Network Processing Unit). A “memory” is a hardware electronic circuit such as a ROM (Read Only Memory) or a RAM (Random Access Memory). A portion of the memory may be a storage medium that is connected to the processor via interconnects or a network. These hardware electronic circuits may be implemented by one or more integrated circuits (IC) or large-scale integrated circuits (LSI). Each functional unit or block and its associated components within the electronic circuit may be individually manufactured as an individual integrated circuit chip, or a portion or a whole of these functional units or blocks may be combined so as to be manufactured as a single integrated circuit chip.

A program defining the operation of a processor is designed so that the processor will execute one or more functions, operations, steps, or process according to an example embodiment of the present disclosure.

As will be described below, the travel control system 1000 is configured or programmed to control the operation of the work vehicle 100 by using a so-called teaching-playback method, which is used in the fields of robot control. The controller 180 of the travel control system 1000 may be configured or programmed to operate in a recording mode and a reproducing mode. The recording mode is a mode in which multiple positions (hereinafter also referred to as “waypoints”) defining a travel path of the work vehicle 100 and operations at the respective waypoints are recorded. The reproducing mode is a mode in which the travel path of the work vehicle 100 and the operations at the respective waypoints that were recorded in the recording mode are reproduced. The operations in the recording mode and the reproducing mode correspond to, respectively, an operation of teaching and an operation of playback in the teaching-playback method. The operations of the controller 180 in the recording mode and the reproducing mode may be referred to as “teaching” and “playback”, respectively. The recording mode may be referred to as the “teaching mode”, and the reproducing mode as the “playback mode”.

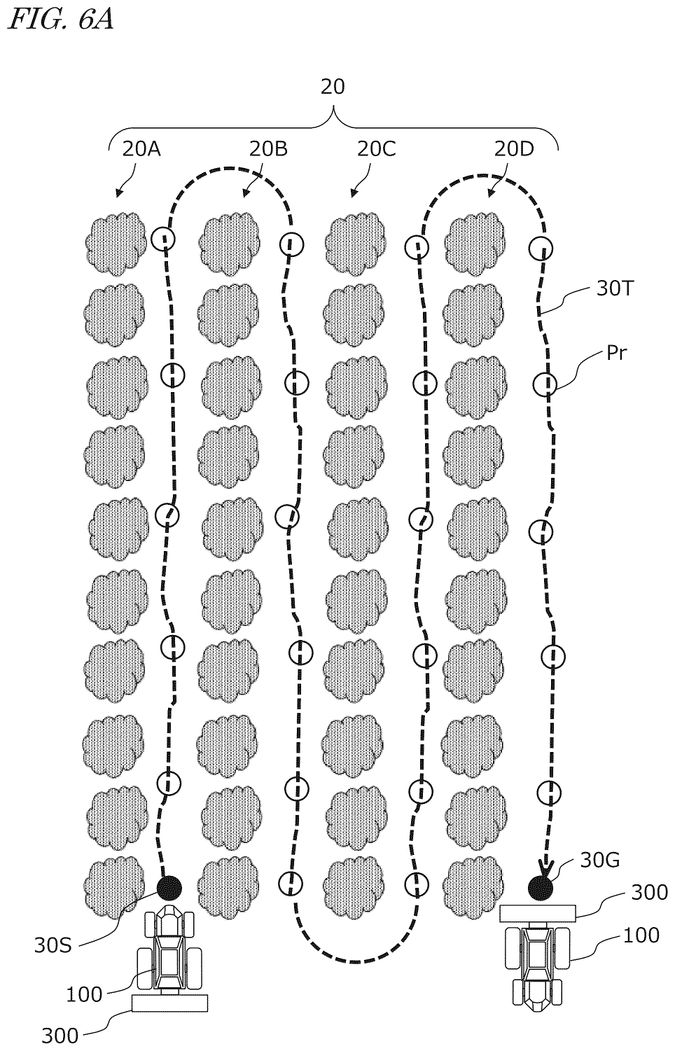

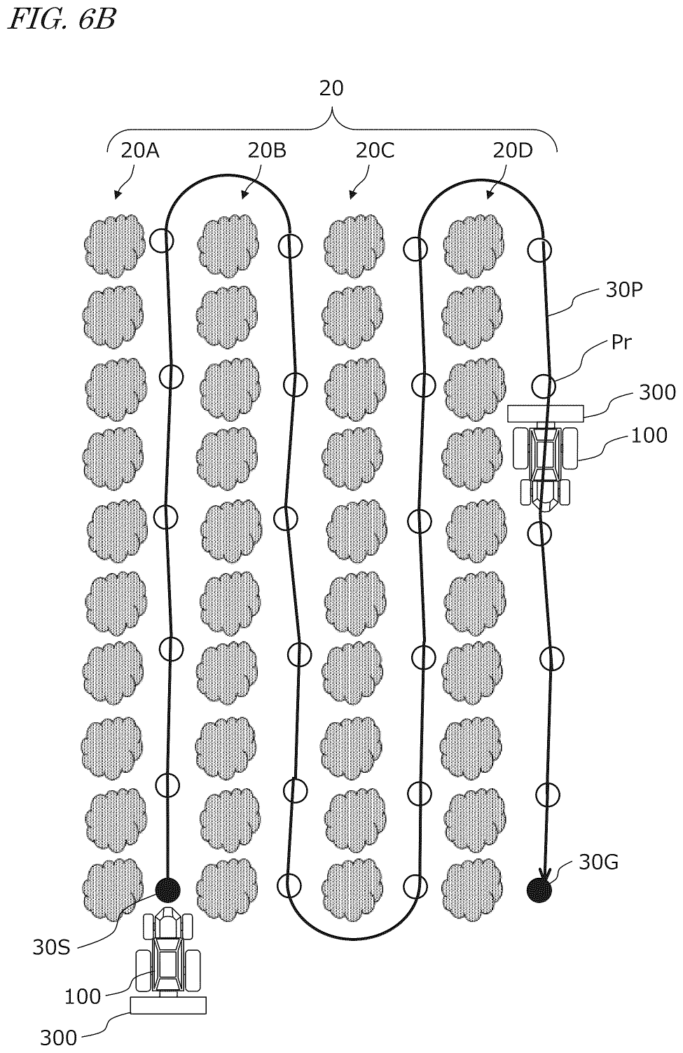

With reference to FIG. 5, FIG. 6A and FIG. 6B, operations of the controller 180 of the travel control system 1000 in the recording mode and the reproducing mode will be described. FIG. 5 is a diagram schematically showing an example of an environment in which the work vehicle 100 travels. FIG. 6A is a diagram schematically showing an example of a path 30T that is traveled by the work vehicle 100 in the recording mode. FIG. 6B is a diagram schematically showing an example of a path 30P that is traveled by the work vehicle 100 in the reproducing mode. In this example, the work vehicle 100 performs predetermined tasks (e.g., mowing, preventive pest control, seeding, manure spreading, etc.) by using the implement 300, while traveling among the plurality of rows of trees 20 (hereinafter also referred to as “crop rows 20”) in an orchard such as a vineyard.

In the recording mode, in the example of FIG. 6A, the work vehicle 100 performs travel while performing work by the implement 300. In the example of FIG. 6A, the work vehicle 100 travels along the path 30T from a start point 30S to an end point 30G. FIG. 6A illustrates a state where the work vehicle 100 is located before the start point 30S and a state where the work vehicle 100 is located at a point beyond the end point 30G. In the recording mode, while the work vehicle 100 is traveling, the controller 180 records multiple pieces of waypoint information to the storage device 870, based on position data that is output from the positioning device 110 and sensor data that is output from the sensor group 150. Each of the multiple pieces of waypoint information includes first information concerning the position of the work vehicle 100 and second information concerning the state of the work vehicle 100. The first information and second information included in each of the multiple pieces of waypoint information indicate a position of the work vehicle 100 and the state of the work vehicle 100 at that position, respectively.

Therefore, the first information may be referred to as “positional information”, and the second information may be referred to as “state information”. Multiple pieces of first information that are included in multiple pieces of waypoint information represent the path 30T that has been traveled by the work vehicle 100. Each of the multiple pieces of second information that are included in the multiple pieces of waypoint information is recorded in association with the corresponding first information. As each of the multiple pieces of second information that are included in the multiple pieces of waypoint information is recorded in association with the corresponding first information, information of the state of the work vehicle 100 at each position on the path 30T that has been traveled by the work vehicle 100 becomes recorded. For example, as shown in FIG. 6A, at each of the multiple positions (waypoints) Pr on the path 30T having been traveled, first information and second information are acquired and recorded as waypoint information.

In the recording mode, the work vehicle 100 may perform manual traveling

via manual operation of the driver, or self-traveling via self-driving. When the work vehicle 100 performs self-traveling in the recording mode, the work vehicle 100 may autonomously travel without involving manual operation of the driver, or perform self-traveling but travel partly based on manual operation of the driver. For example, an automatic steering control may be performed during travel in the recording mode, such that the driver performs control of the traveling speed of the work vehicle 100 while steering control is automatically performed. Alternatively, during travel in the recording mode, the work vehicle 100 may perform self-traveling, while the implement 300 operates via manual operation of the driver. Manual operation of the driver includes not only manual operation of the driver on the work vehicle 100, but also remote operation by a driver (operator) outside the work vehicle 100. Such remote operations may be performed by using the terminal devices 600 shown in FIG. 4, or other remote operation devices, for example.

The second information broadly includes information concerning states of the work vehicle 100 other than its position. The second information includes information concerning operation of the work vehicle 100, e.g., a traveling state, for example. The traveling state of the work vehicle 100 is defined by velocity, acceleration (i.e., rate of change in velocity per unit time), traveling direction (azimuth), and the like of the work vehicle 100. Information concerning the traveling state of the work vehicle 100 includes any one or more of information of the velocity of the work vehicle 100, information of the engine speed of the work vehicle 100, information of the acceleration of the work vehicle 100, information of the azimuth of the work vehicle 100, information of the steering angle of the wheels responsible for steering of the work vehicle 100, information of the gear ratio of the transmission 103 of the work vehicle 100, and the like, for example. The second information may include information of the attitude of the work vehicle 100. Information of the attitude of the work vehicle 100 includes information of the azimuth of the work vehicle 100, for example. Without being limited to information concerning the operation of the work vehicle 100, the second information may include information of the temperature of the work vehicle 100 (e.g., temperature of the engine coolant), information concerning the presence/absence of problems of the work vehicle 100 (e.g., Diagnostic Trouble Code: DTC), and the like, for example. Specific examples of methods of acquiring the second information will be described later.

The second information may include information concerning the state of the linkage device 108 to enable linking of the implement 300. The linkage device 108 may include the PTO shaft for supplying motive power to the implement 300 and a three-point hitch for adjusting the height of the implement 300, for example. Information concerning the state of the linkage device 108 may include any one or more of information of rotation ON or OFF of the PTO shaft, and information of the height of the three-point hitch, for example.

In a case where the work vehicle 100 has the implement 300 linked thereto, the second information may include, in addition to information concerning the state of the work vehicle 100, information concerning the state of the implement 300. For example, in a case where the implement 300 has a positioning device mounted thereto, information of the position or azimuth (e.g., angle with respect to a reference azimuth) of the implement 300 may be included in the second information. Alternatively, in a case where a sensor to detect the operation of a movable member in the implement 300 is provided in the implement 300, information that is detected by that sensor may be included in the second information.

In the reproducing mode, the work vehicle 100 performs travel via self-driving. While causing the work vehicle 100 to perform self-traveling based on the first information and second information included in multiple pieces of waypoint information recorded in the recording mode, the controller 180 is configured or programmed to control the operation of the work vehicle 100. In the example of FIG. 6B, based on the first information (positional information) and the second information (state information) included in the multiple pieces of waypoint information recorded when traveling along the path 30T (see FIG. 6A) in the recording mode, the work vehicle 100 performs self-traveling. In the reproducing mode, the controller 180 causes the work vehicle 100 to travel along a target path 30P that is defined by the first information included in the multiple pieces of waypoint information recorded in the recording mode. For example, the controller 180 performs steering control for the work vehicle 100 so as to minimize deviations of the position and orientation (azimuth) of the work vehicle 100 with respect to the target path 30P. This allows the work vehicle 100 to travel along the target path 30P. In the reproducing mode, the work vehicle 100 is able to automatically reproduce the operation of the work vehicle 100 that was recorded in the recording mode.

The reproducing mode is begun in a state where the work vehicle 100 is located at the start point 30S of the target path 30P, for example. As the work vehicle 100 reaches the end point 30G of the target path 30P, for example, the controller 180 ends the reproducing mode. FIG. 6B illustrates a state where the work vehicle 100 is located before the start point 30S and a state where the work vehicle 100 is located somewhere along the path 30P.

As in the examples of FIG. 6A and FIG. 6B, in a case where the work vehicle 100 has the implement 300 linked thereto, based on the first information and second information included in multiple pieces of waypoint information recorded in the recording mode, the controller 180 can control the operations of the work vehicle 100 and the implement 300, while causing the work vehicle 100 to perform self-traveling. In other words, in the reproducing mode, the work vehicle 100 can automatically reproduce not only the operation of the work vehicle 100 that was recorded in the recording mode, but also the operation of the implement 300.

With the travel control system according to the present example embodiment, in the reproducing mode, it is possible to reproduce the operation of the work vehicle 100 that was recorded in the recording mode, such that iterative operations of the work vehicle 100 can be efficiently performed. In the recording mode, the second information concerning the state of the work vehicle 100 other than its position is recorded in association with the first information concerning the position of the work vehicle 100 to promote automation and unmanned execution of the operation of the work vehicle 100.

In a case where the work vehicle 100 has the implement 300 linked thereto, in the reproducing mode, the work vehicle 100 can automatically reproduce not only the operation of the work vehicle 100 that was recorded in the recording mode, but also the operation of the implement 300 such that iterative work to be performed by the implement 300 can be efficiently carried out. In the recording mode, second information concerning the state of the implement 300 is recorded in association with the first information concerning the position of the work vehicle 100 to promote automation and unmanned execution of the work by the implement 300.

In the examples of FIG. 6A and FIG. 6B, the work vehicle 100 travels along the path 30T or the path 30P among the plurality of rows of trees 20. More specifically, the work vehicle 100 travels between two adjacent rows of trees 20, and turns in a headland before and after the travel between the two adjacent rows of trees 20. A headland is a region between an end of each row of trees and the boundary of the orchard. Specifically, the following operation may be performed. Let the plurality of rows of trees 20 be sequentially designated as a first row of trees 20A, a second row of trees 20B, a third row of trees 20C, a fourth row of trees 20D, . . . , from the end. From the start point 30S, the work vehicle 100 first travels between the first row of trees 20A and the second row of trees 20B, and upon completing this travel, turns right to travel between the second row of trees 20B and the third row of trees 20C in the opposite direction. Once the travel between the second row of trees 20B and the third row of trees 20C is completed, it further turns left to travel between the third row of trees 20C and the fourth row of trees 20D. Thereafter, by repeating a similar operation, the work vehicle 100 travels to the end point 30G of the path 30T or the path 30P.

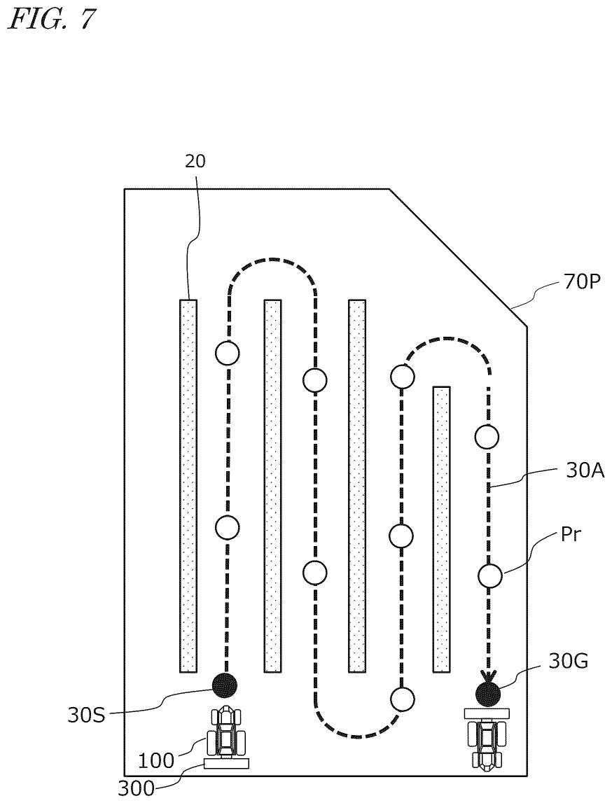

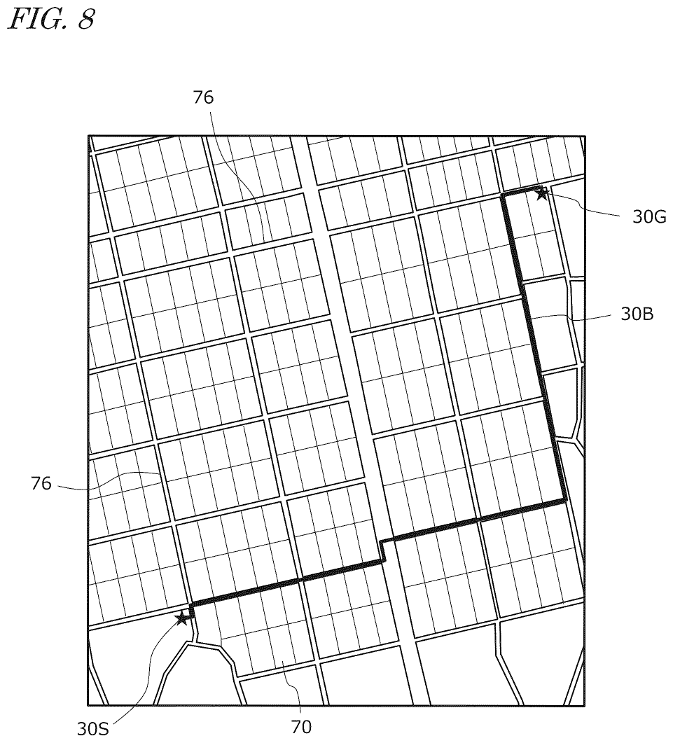

FIG. 7 and FIG. 8 are diagrams schematically showing other examples of paths that are traveled by the work vehicle 100.

FIG. 7 shows, in a non-rectangular field 70P, a path 30A along which the work vehicle 100 travels among a plurality of crop rows 20. In the recording mode, the work vehicle 100 travels along the path 30A from a start point 30S to an end point 30G. In the reproducing mode, the controller 180 causes the work vehicle 100 to perform self-traveling along a target path that is defined by the first information included in multiple pieces of waypoint information recorded in the recording mode. As shown in FIG. 7, autonomous travel may not be easy in a non-rectangular field because the crop rows 20 may differ from one another in length. By using the travel control system according to the present example embodiment, iterative operations of the work vehicle 100 can be efficiently performed even in a non-rectangular field to promote automation and unmanned execution of the operation of the work vehicle 100.

FIG. 8 shows a path 30B along which the work vehicle 100 travels, outside the fields 70. The region depicted in FIG. 8 includes a number of fields 70 where the work vehicle 100 performs agricultural work, and roads 76 around the fields. The roads 76 may be agricultural roads. In the recording mode, the work vehicle 100 travels along the path 30B from a start point 30S to an end point 30G. In the reproducing mode, the controller 180 causes the work vehicle 100 to perform self-traveling along a target path that is defined by the first information included in multiple pieces of waypoint information recorded in the recording mode. As shown in FIG. 8, the travel control system according to the present example embodiment is also applicable to travel that is performed outside the fields. For example, it is suitably applicable to any manner of travel that is performed iteratively, e.g., movements of the work vehicle 100 from field to field or movements of the work vehicle 100 between its storage location and a field. In such a case, iterative operations (which herein is movements) of the work vehicle 100 can be efficiently performed to promote automation and unmanned execution of the operation (which herein is movements) of the work vehicle 100.

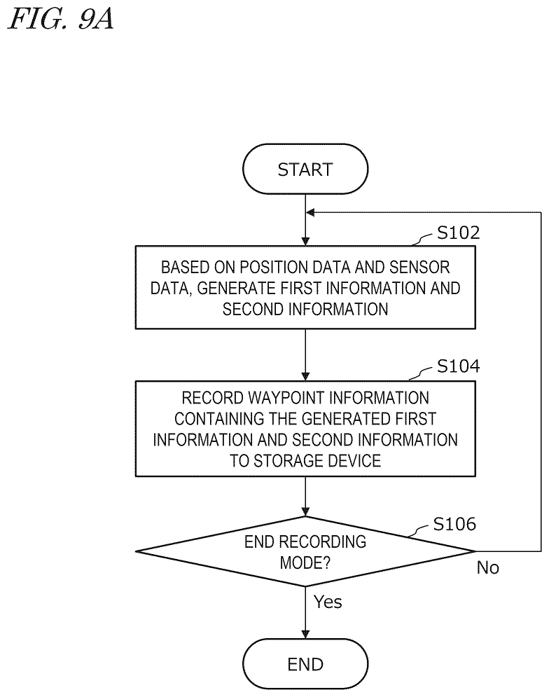

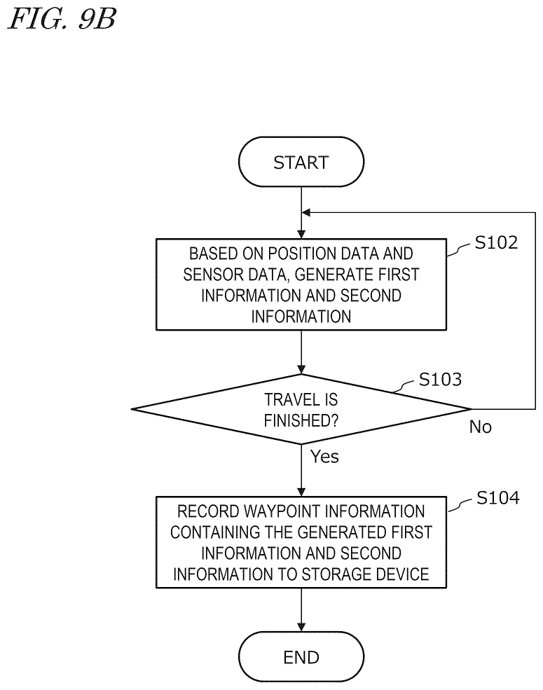

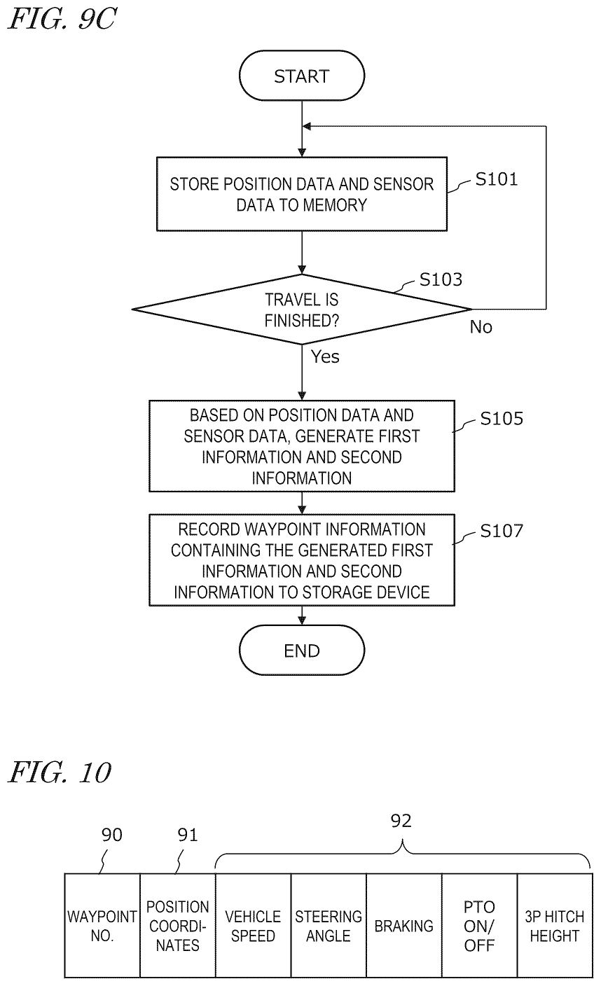

FIG. 9A is a flowchart showing an example processing to be performed in the recording mode.

The timing of beginning the recording mode is designated by the user, for example. For instance, the controller 180 may begin the recording mode when a signal including an instruction to begin the recording mode is transmitted to the controller 180 through an operation of the driver. For instance, the driver on the work vehicle 100 can transmit a signal including an instruction to begin the recording mode to the controller 180 by operating an input device such as the operation terminal 200 or a predetermined operation switch provided in the work vehicle 100. The recording mode may be begun during travel of the work vehicle 100, or begun while the work vehicle 100 is at a halt.

Once the recording mode is begun, then at step S102, while the work vehicle 100 is traveling, the controller 180 generates first information and second information based on position data that is output from the positioning device 110 and sensor data that is output from the sensor group 150. For example, the controller 180 may calculate the position (i.e., coordinates) of a reference point on the work vehicle 100 based on position data that is output from the positioning device 110, and generate (acquire) information indicating this position as the first information. Based on the position data that is output from the positioning device 110 and information indicating a relative position relationship between the positioning device 110 and the work vehicle 100 that is recorded in the storage device in advance, the controller 180 can calculate the position of the reference point on the work vehicle 100. Moreover, as the second information, the controller 180 may generate, based on sensor data that is output from the sensor group 150, information that is necessary for controlling various actuators to be driven during playback.

The first information and second information may be generated at any arbitrary timing. The first information and second information may be generated each time the work vehicle 100 travels a certain distance, or each time a certain period passes, for example. The aforementioned certain distance (e.g., distance between two adjacent waypoints Pr along the traveling direction of the work vehicle 100 in the example of FIG. 6A) may be set to a value on the order of several ten centimeters (cm) to several meters (m), for example. The aforementioned certain period may be set to a value in the range from 1 second to 10 seconds, for example.

At step S104, the controller 180 records waypoint information including the first information and second information generated in step S102 to the storage device 870 (see FIG. 3A). The first information and second information are recorded in association with each other.

FIG. 10 is a diagram showing an example of waypoint information. The waypoint information depicted in FIG. 10 includes a waypoint number (No.) 90, first information 91 indicating the position of the work vehicle 100, and second information 92 indicating the state of the work vehicle 100. The first information 91 represents the position coordinates of that waypoint. For example, the position coordinates may indicate a latitude and a longitude in a geographic coordinate system, or indicate position coordinates in a coordinate system other than a geographic coordinate system. In addition to a latitude and a longitude, the position coordinates may include altitude information. The second information 92 in the example of FIG. 10 includes information as to a vehicle speed, a steering angle, whether braking is applied or not, ON/OFF of the PTO shaft, and the height of the 3P hitch. The second information 92 may include only portion of such information. Alternatively, the second information 92 may include other information not shown in FIG. 10. For example, information indicating the state of a forward/reverse lever may be included in the second information 92. Alternatively, ON/OFF information of a front wheel speed increasing function (also referred to as “bi-speed turn”) may be included in the second information 92.

Until an instruction to end the recording mode is given (step S106), the controller 180 repeats the processes of step S102 and step S104. The timing of ending the recording mode may be designated by the user. For example, the controller 180 may end the recording mode when a signal including an instruction to end the recording mode is transmitted to the controller 180 through an operation of the driver. For instance, the driver on the work vehicle 100 can transmit a signal including an instruction to end the recording mode to the controller 180 by operating an input device such as the operation terminal 200 or a predetermined operation switch provided in the work vehicle 100.

FIG. 9B is a flowchart showing another example processing to be performed by the controller 180 in the recording mode. The flowchart of FIG. 9B differs from the flowchart of FIG. 9A in that step S104 is performed at a timing that is after the travel in the recording mode is finished.

In the example shown in FIG. 9B, after the travel of the work vehicle 100 in the recording mode is finished (step S103), the controller 180 performs the process of step S104. At step S104, multiple pieces of waypoint information including the first information and second information generated during travel of the work vehicle 100 in step S102 are recorded to the storage device 870. The first information and second information generated in step S102 may be temporarily stored to the storage device 870 or a storage device (e.g., a memory such as the RAM 285 shown in FIG. 3B) distinct from the storage device 870, and erased after the waypoint information has been recorded. In this example, after the travel in the recording mode is finished, waypoint information as shown in FIG. 10 is generated for each waypoint, and recorded.

FIG. 9C is a flowchart showing still another processing to be performed by the controller 180 in the recording mode. The flowchart shown in FIG. 9C differs from the flowchart shown in FIG. 9B in that the first information and the second information are generated after the travel in the recording mode is finished.

In the example shown in FIG. 9C, at step S101, while the work vehicle 100 is traveling, the controller 180 stores position data that is output from the positioning device 110 and sensor data that is output from the sensor group 150 to the memory (e.g., the RAM 285 shown in FIG. 3B). After the travel of the work vehicle 100 in the recording mode is finished (step S103), the controller 180 performs the processes of steps S105 and S107. At step S105, for each of multiple waypoints, the controller 180 generates first information and second information based on the position data and sensor data stored in the memory. At step S107, the controller 180 records multiple pieces of waypoint information, each including first information and second information, to the storage device 870. In this example, after the travel in the recording mode is finished, first information and second information are generated for each waypoint, and waypoint information as shown in FIG. 10 is recorded for each waypoint.

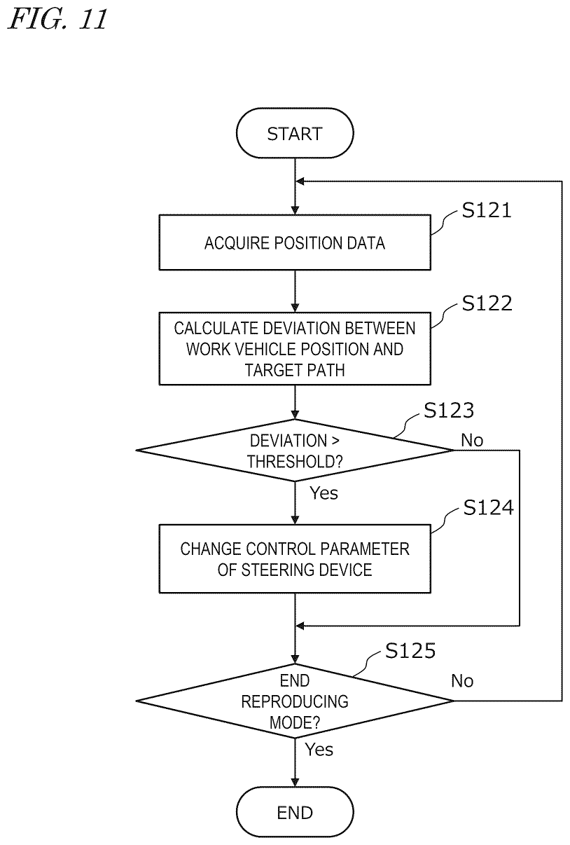

FIG. 11 is a flowchart showing an example processing to be performed in the reproducing mode.

In the reproducing mode, based on previously recorded waypoint information, the controller 180 causes the work vehicle 100 to automatically travel. The controller 180 acquires position data indicating the position of the work vehicle 100 that is output from the positioning device 110 (step S121). Next, the controller 180 calculates a deviation between the position of the work vehicle 100 and a target path (step S122). The target path is defined by positional information (first information) of multiple waypoints that are recorded in the recording mode. The deviation represents a distance between the position of the work vehicle 100 at that moment and the target path. The controller 180 determines whether the calculated deviation in position exceeds a previously-set threshold or not (step S123). If the deviation exceeds the threshold (“Yes” from step S123), the controller 180 changes a control parameter of the steering device 106 included in the driver 240 so that the deviation becomes smaller to change the steering angle (step S124). If step S123 finds that the deviation does not exceed the threshold (“No” from step S123), the process of step S124 is not performed. Until an instruction to end the reproducing mode is given (step S125), the controller 180 repeats the operation from step S121 to step S124.

In the reproducing mode, by performing the process shown in FIG. 11, for example, the controller 180 causes the work vehicle 100 to perform self-traveling along the target path. Furthermore, based on the state information (second information) corresponding to each of the multiple waypoints defining the target path, the controller 180 controls the operation of the work vehicle 100. For example, if the second information includes information of the steering angle of the wheels responsible for steering of the work vehicle 100, in addition to the processing shown in FIG. 11, a control of the steering of the work vehicle 100 is performed based on the steering angle included in the second information. If the second information includes information of the speed of the work vehicle 100, the speed of the work vehicle 100 is controlled based on the information of speed included in the second information. Further alternatively, if an operation has been recorded such that rotation of the PTO shaft is stopped (OFF) before beginning a turn and rotation of the PTO shaft is started (ON) after completion of the turn, then the controller 180 reproduces that operation at a turn of the work vehicle 100 in the reproducing mode.

For the steering control and speed control of the work vehicle 100, control techniques such as PID control or MPC control (model predictive control) may applied. By applying such control techniques, the control of bringing the work vehicle 100 closer to a target path and a target speed can be made smooth.

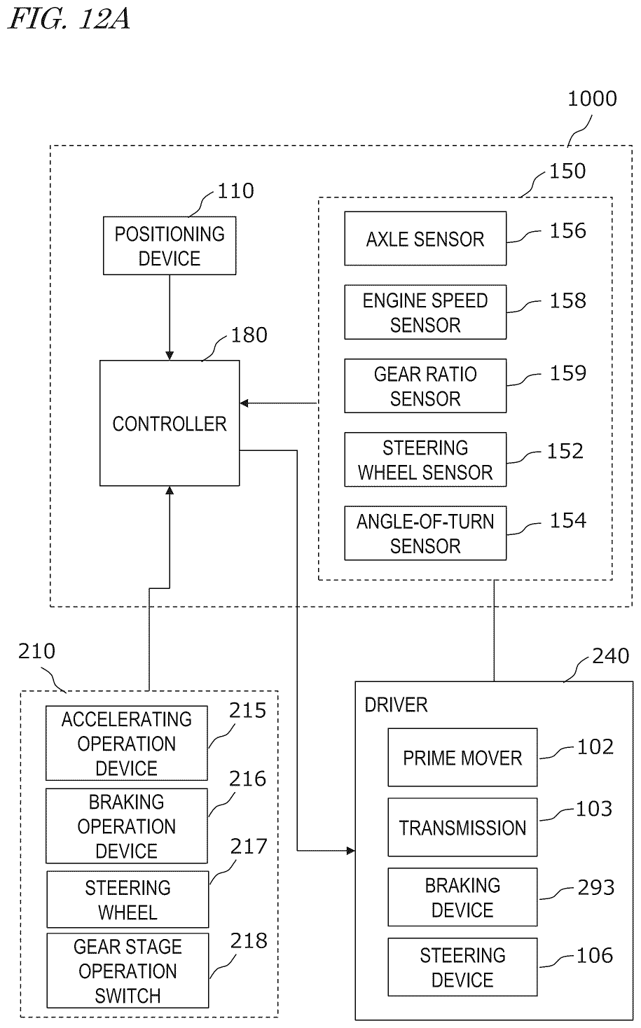

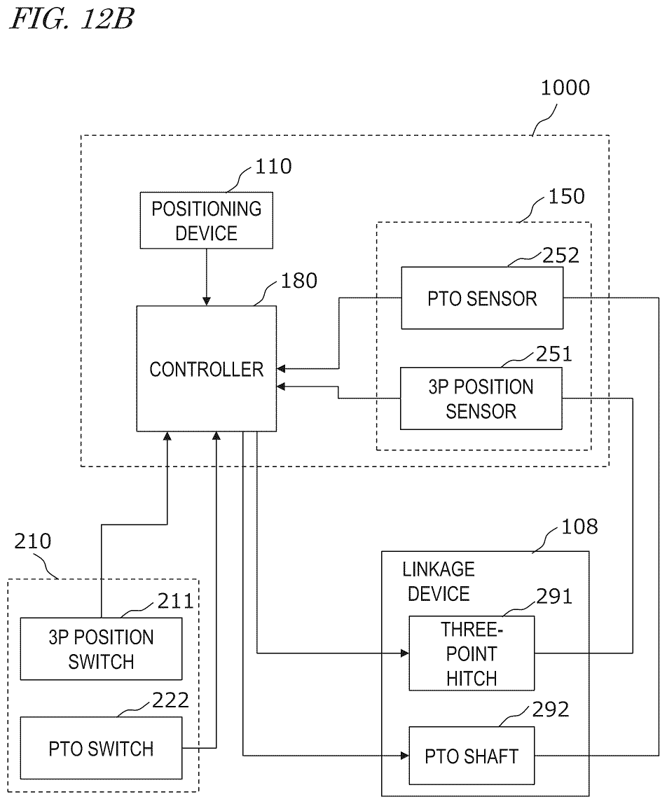

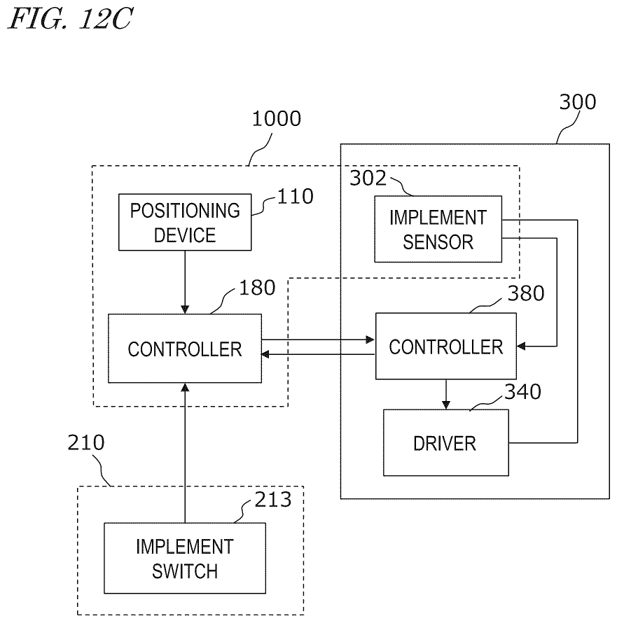

With reference to FIG. 12A, an example processing to be performed by the controller 180 in a case where the second information includes information concerning the traveling state of the work vehicle 100 will be described. FIG. 12A is a schematic diagram for describing an example processing to be performed by the controller 180 of the travel control system 1000. In addition to the travel control system 1000, FIG. 12A also shows the driver 240 and the operation switches 210. For simplicity, some component elements are omitted from illustration in FIG. 12A.

By controlling the prime mover 102, the braking device (brakes) 293, and the transmission 103 included in the driver 240, the controller 180 controls the speed of the work vehicle 100. The braking device 293 applies braking to the axle that rotates the wheels 104 of the work vehicle 100. Specifically, by controlling the engine speed of the prime mover (engine) 102 and/or the gear ratio of the transmission 103, the speed of the work vehicle 100 can be controlled. For example, the transmission 103 has multiple gear stages, and the controller 180 controls the gear ratio of the transmission 103 by switching the gear stages of the transmission 103. The multiple gear stages of the transmission 103 may be configured by a combination of multiple main gear stages and multiple range gear stages. When the work vehicle 100 is performing manual traveling, the controller 180 controls the speed of the work vehicle 100 by controlling the prime mover 102, the braking device (brakes) 293, and the transmission 103 in response to the driver's operation of an accelerating operation device 215 (e.g., an accelerator lever or an accelerator pedal), a braking operation device 216 (e.g., a brake pedal), and/or a gear stage operation switch 218 (e.g., a shift lever). The gear stage operation switch 218 is a switch to select a gear stage of the transmission 103. The controller 180 may further switch between a two-wheel drive mode and a four-wheel drive mode in response to the driver's operation.

In the recording mode, the controller 180 consecutively acquires sensor data that is output from vehicle speed sensors such as the axle sensor 156, an engine speed sensor 158, and a gear ratio sensor 159 that detects information of the gear ratio of the transmission 103. Based on such sensor data, as second information, the controller 180 generates and records information of the speed of the work vehicle 100, information of the engine speed of the work vehicle 100, and information of the gear ratio of the transmission 103, in association with the positional information (first information) of each waypoint. In such a case, in the reproducing mode, the controller 180 controls the speed of the work vehicle 100 by controlling the prime mover 102, the transmission 103, and the braking device 293 included in the driver 240 based on the second information that was recorded in the recording mode. The gear ratio sensor 159 may be a sensor which is provided on a rotation axis within the transmission 103 and which detects the gear ratio, or a shift position sensor that detects the position of the shift lever (gear stage operation switch 218) for selecting a gear stage to identify the selected gear stage. Without being limited to information that indicates the gear ratio itself, information of the gear ratio of the transmission 103 may be information that identifies a selected gear stage among the plurality of gear stages of the transmission 103, for example. Since one gear stage corresponds to one gear ratio, identifying a gear stage allows the gear ratio to be identified.

The work vehicle 100 may have a bi-speed turn function (front wheel speed increasing function). A bi-speed turn is an operation in which, when a driver steers the steering wheel so much that the steering angle of the front wheels exceeds a threshold, the speed of the front wheels is increased. Performing a bi-speed turn allows the turning radius to be decreased, thus resulting in a smoother turn. The work vehicle 100 may include a solenoid (referred to as a “bi-speed solenoid”) for driving a clutch that switches the bi-speed turn function ON/OFF. The controller 180 can switch the bi-speed solenoid ON/OFF via a hydraulic circuit. When the bi-speed solenoid is ON, the rotational speed of the front wheels is about twice that of the case where the bi-speed solenoid is OFF.

The second information may further include information concerning the traveling mode of the work vehicle 100. For example, information concerning the traveling mode of the work vehicle 100 may include information as to forward travel or backward travel. Information concerning the traveling mode may include information as to whether the traveling mode of the work vehicle 100 is in a four-wheel drive mode or a two-wheel drive mode. Information concerning the traveling mode may include information as to whether the bi-speed turn function is ON or OFF. Information concerning the traveling mode may further include information as to whether an automatic single brake mode is ON or OFF. The automatic single brake mode is a mode which, when ON, applies slight braking to the inner rear wheels when the steering angle of the front wheels 104F (which are the wheels responsible for steering) exceeds a predetermined value during travel. In the reproducing mode, the controller 180 is configured or programmed to control the traveling mode of the work vehicle 100, by controlling the prime mover 102, the transmission 103, and the braking device 293 included in the driver 240 based on the second information that was recorded in the recording mode.

The controller 180 changes the steering angle of the front wheels 104F (which are the wheels responsible for steering of the work vehicle 100) by controlling the steering device 106, and changes the azimuth of the work vehicle 100 by changing the steering angle of the wheels responsible for steering. When the work vehicle 100 is performing manual traveling, the controller 180 changes the steering angle of the wheels responsible for steering and the azimuth of the work vehicle 100 of the work vehicle 100 by controlling the steering device 106 in response to the driver's operation of the steering wheel 217.

In the recording mode, based on sensor data (measurement values) that is output from the steering wheel sensor 152 and/or the angle-of-turn sensor 154, the controller 180 acquires, as second information, information of the steering angle of the wheels responsible for steering of the work vehicle 100. In such a case, in the reproducing mode, the controller 180 controls steering of the work vehicle 100 by controlling the hydraulic device or the electric motor included in the steering device 106 based on the second information that was recorded in the recording mode.

The second information may further include information concerning the attitude of the work vehicle 100. The attitude of the work vehicle 100 is represented by a roll angle θ_{R}, a pitch angle θ_{P}, and a yaw angle θ_{Y}, for example. A roll angle θ_{R} represents the amount of rotation of the work vehicle 100 around its front-rear axis. A pitch angle θ_{P} represents the amount of rotation of the work vehicle 100 around its right-left axis. A yaw angle θ_{Y} represents the amount of rotation of the work vehicle 100 around its top-bottom axis. The attitude may be defined by an Euler angle or other angles, or a quaternion. The controller 180 acquires information concerning the attitude of the work vehicle 100 based on data that is output from the IMU 115, for example.

With reference to FIG. 12B, an example processing to be performed by the controller 180 in a case where the second information includes information concerning the state of the linkage device 108 for enabling linking of the implement 300 will be described. FIG. 12B is a schematic diagram for describing an example processing to be performed by the controller 180 of the travel control system 1000. In addition to the travel control system 1000, FIG. 12B also shows the linkage device 108 and the operation switches 210.

As shown in FIG. 12B, the linkage device 108 includes a three-point hitch 291 for connecting the implement 300, and a PTO shaft 292 to supply motive power of rotation to the implement 300. The operation switches 210 include a 3P position switch 211 for performing an operation of changing the height of the three-point hitch 291, and a PTO switch 222 for performing an operation of switching ON/OFF the rotation of the PTO shaft 292. The sensor group 150 includes a 3P position sensor 251 to detect the position in the height direction of the three-point hitch 291, and a PTO sensor 252 to detect rotation ON/OFF of the PTO shaft 292. Each of the linkage device 108, the operation switches 210, and the sensor group 150 may include other component elements. However, for simplicity, some component elements are omitted from illustration in FIG. 12B. The controller 180 is connected to the 3P position sensor 251, the PTO sensor 252, the three-point hitch 291, and the PTO shaft 292. The controller 180 is capable of performing communications between itself and these component elements by utilizing a communication protocol such as CAN.

The controller 180 controls the height of the three-point hitch 291 and switching ON/OFF of the rotation of the PTO shaft 292. In a case where the work vehicle 100 is operating via manual operation of the driver, the controller 180 changes the height of the three-point hitch 291 in response to the driver's operation of the 3P position switch 211, and switches rotation ON/OFF of the PTO shaft 292 in response to the driver's operation of the PTO switch 222.

In the recording mode, based on sensor data that is output from the 3P position sensor 251, the controller 180 generates, as second information, information concerning the height of the three-point hitch 291. In such a case, in the reproducing mode, the controller 180 controls the height of the three-point hitch 291 based on the second information that was recorded in the recording mode. Moreover, in the recording mode, the controller 180 acquires, as second information, information concerning rotation ON/OFF of the PTO shaft 292 based on sensor data that is output from the PTO sensor 252. In such a case, in the reproducing mode, the controller 180 controls rotation ON/OFF of the PTO shaft 292 based on the second information that was recorded in the recording mode.

With reference to FIG. 12C, an example processing to be performed by the controller 180 in a case where the work vehicle 100 has the implement 300 linked thereto and the second information includes information concerning the state of the implement 300 will be described. FIG. 12C is a schematic diagram for describing an example processing to be performed by the controller 180 of the travel control system 1000. In addition to the travel control system 1000, FIG. 12C also shows the implement 300 and the operation switches 210. For simplicity, some component elements are omitted from illustration in FIG. 12C.

As shown in FIG. 12C, the implement 300 includes the driver 340 to perform necessary operations for the implement 300 to perform predetermined tasks, the controller 380 to control the operation of the driver 340, and one or more implement sensors 302 to detect the state of the driver 340 and output sensor data. The driver 340 includes a device that is adapted to the use of the implement 300, such as a hydraulic device, an electric motor, or a pump, for example. The implement sensor 302 has a structure that is adapted to the driver 340, and includes a hydraulic sensor, for example. The operation switches 210 include an implement switch 213 for operating the operation of the implement 300.

By sending a command to control the operation of the driver 340 to the controller 380, the controller 180 controls the operation of the implement 300. In a case where the work vehicle 100 is operating via manual operation of the driver, the controller 180 controls the operation of the implement 300 by sending a command to the controller 380 to control the operation of the driver 340, in response to the driver's operation of the implement switch 213.

In the recording mode, the controller 180 acquires or generates, as second information, information concerning the state of the implement 300, based on sensor data that is output from the implement sensor 302. For example, the controller 380 may generate second information concerning the state of the implement 300 based on sensor data that is output from the implement sensor 302, and transmit the second information to the controller 180. Alternatively, the controller 180 may receive sensor data that is output from the implement sensor 302 via the controller 380, and generate information concerning the state of the implement 300. In such a case, in the reproducing mode, the controller 180 controls the operation of the implement 300 by causing the controller 380 to control the operation of the driver 340 based on the second information that was recorded in the recording mode.

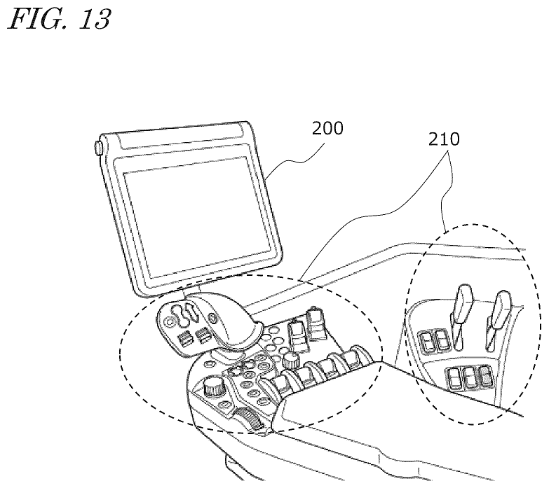

FIG. 13 is a diagram showing an example of an operation terminal 200 and operation switches 210 provided inside the cabin 105 of the work vehicle 100. Inside the cabin 105, operation switches 210 including a plurality of switches that can be operated by the driver are provided. The operation switches 210 may include examples of operation switches that have been described with reference to FIG. 12A, FIG. 12B, and FIG. 12C.

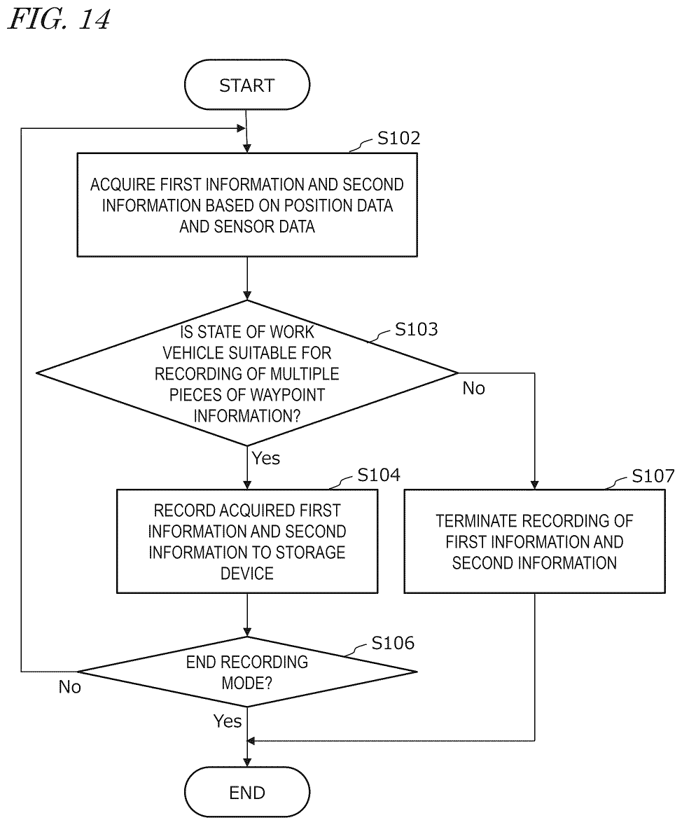

FIG. 14 is a flowchart showing an example processing to be performed by the controller 180 in the recording mode. As will be described below, in the example of FIG. 14, the controller 180 may terminate recording of multiple pieces of waypoint information in the recording mode. Description may be omitted for any aspects that are common to the flowchart of FIG. 9A.

As shown in FIG. 14, once the recording mode is begun, at step S102, the controller 180 acquires first information and second information based on position data that is output from the GNSS unit 110 and sensor data that is output from the sensor group 150. The process of step S102 may be performed similarly to the process in the example of FIG. 9A.

At step S103, based on the position data and sensor data acquired in step S102, the controller 180 determines whether the state of the work vehicle 100 presents a state that is suitable for recording multiple pieces of waypoint information or not. The determination as to whether the state of the work vehicle 100 presents a state that is suitable for recording multiple pieces of waypoint information may be made through determining whether it is detected that the state of the work vehicle 100 presents a state that is unsuitable for recording multiple pieces of waypoint information, for example. For example, the controller 180 determines whether the state of the work vehicle 180 satisfies a predetermined termination condition or not, and if the state of the work vehicle 180 satisfies the termination condition, then it is decided that the state of the work vehicle 100 presents a state that is unsuitable for recording multiple pieces of waypoint information has been detected. If the state of the work vehicle 180 does not satisfy the termination condition, this means it is NOT detected that the state of the work vehicle 100 presents a state that is unsuitable for recording multiple pieces of waypoint information, and thus it is decided that the state of the work vehicle 100 presents a state that is suitable for recording multiple pieces of waypoint information. Specific examples of the termination condition will be described below.

At step S103, if it is determined that the state of the work vehicle 100 presents a state that is suitable for recording multiple pieces of waypoint information (“Yes” from step S103), the controller 180 performs the process of step S104. The process of step S104 may be performed similarly to the process in the example of FIG. 9A. Until a command to end the recording mode is given (step S106), the controller 180 repeats the process of step S102, step S103, and step S104.

At step S103, if it is detected that the state of the work vehicle 100 presents a state that is unsuitable for recording multiple pieces of waypoint information (“No” from step S103), then at step S107, the controller 180 terminates recording of multiple pieces of waypoint information. When recording of multiple pieces of waypoint information is terminated, the controller 180 may cause a display device of the work vehicle 100 (e.g., a display device included in the operation terminal 200) to display an indication notifying the user that recording of multiple pieces of waypoint information has been terminated.

As shown in FIG. 14, in the recording mode, if it is detected that the state of the work vehicle 100 presents a state that is unsuitable for recording multiple pieces of waypoint information, the controller 180 terminates recording of multiple pieces of waypoint information. Cases where the state of the work vehicle 100 presents a state that is unsuitable for recording multiple pieces of waypoint information may include the following, for example: the state of the work vehicle 100 being in a state (e.g., a traveling mode) incompatible with self-driving that is performed in the reproducing mode, occurrence of a state or an operation of the work vehicle 100 that is not favorable for reproduction in the reproducing mode, a state where the work vehicle 100 is experiencing malfunctioning or abnormality, and any other states of the work vehicle 100 that are classified as not being suitable for recording of multiple pieces of waypoint information. Recording multiple pieces of waypoint information including the first information and second information that are acquired while the state of the work vehicle 100 corresponds to any of the above states may result in the following issues, for example: reproducibility of operations of the work vehicle 100 under the reproducing mode may deteriorate such that self-traveling of the work vehicle 100 in the reproducing mode may not be smoothly performed; or operations that are not favorable for reproduction from the standpoint of enhancing the efficiency of iterative operations of the work vehicle 100 may become reproduced in the reproducing mode. In such cases, the efficiency of iterative operations of the work vehicle 100 may not be sufficiently enhanced. On the other hand, as shown in FIG. 14, if it is detected that the state of the work vehicle 100 presents a state that is unsuitable for recording multiple pieces of waypoint information, the controller 180 terminates recording of multiple pieces of waypoint information. As a result, reproducibility of operations of the work vehicle 100 under the reproducing mode can be enhanced, and self-traveling of the work vehicle 100 in the reproducing mode can be smoothly performed. Thus, the efficiency of iterative operations of the work vehicle 100 can be improved.

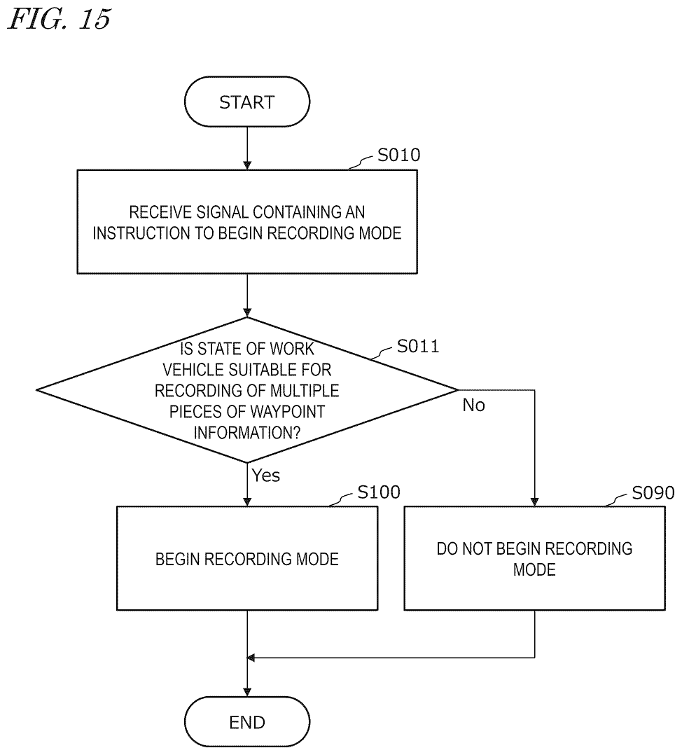

FIG. 15 is a flowchart showing an example processing to be performed by the controller 180. The flowchart of FIG. 15 illustrates an example processing to be performed by the controller 180 when a signal including an instruction to begin the recording mode is received. The processing of FIG. 15 may be combined with the processing of FIG. 14.

At step S010, the controller 180 receives a signal including an instruction to begin the recording mode. For example, in response to the driver's operation, a signal including an instruction to begin the recording mode is transmitted to the controller 180.

After step S010, at step S011, the controller 180 determines whether the state of the work vehicle 100 presents a state that is suitable for recording multiple pieces of waypoint information or not. The determination of step S011 may be performed similarly to the determination of step S103 in the flowchart of FIG. 14.

If step S011 finds that the state of the work vehicle 100 presents a state that is suitable for recording multiple pieces of waypoint information (“Yes” from step S011), the controller 180 begins the recording mode (step S100). Once the recording mode is begun, in the recording mode, the processing of the flowchart of FIG. 14 is performed, for example.

At step S011, if it is detected that the state of the work vehicle 100 presents a state that is unsuitable for recording multiple pieces of waypoint information (“No” from step S011), the controller 180 does not begin the recording mode (step S090). In the case of not beginning the recording mode, the controller 180 may cause a display device of the work vehicle 100 (e.g., a display device included in the operation terminal 200) to display an indication notifying the user that the state of the work vehicle 100 presents a state that is unsuitable for recording multiple pieces of waypoint information.

Specific examples of the termination condition will be described below. As described above, in determining whether the state of the work vehicle 100 presents a state that is suitable for recording multiple pieces of waypoint information or not, the controller 180 may determine whether the state of the work vehicle 180 satisfies the termination condition. Specifically, the controller 180 determines whether the state of the work vehicle 100 meets any of one or more predetermined conditions. If any such condition is met, it is determined that the state of the work vehicle 180 satisfies the termination condition. In the recording mode, based on sensor data that is output from the sensor group 150, the controller 180 acquires information that is necessary for the determination as to whether the state of the work vehicle 180 satisfies the termination condition or not, and based on the acquired information, makes this determination. As information that is necessary for the determination as to whether the state of the work vehicle 180 satisfies the termination condition or not, information acquired by the controller 180 may be recorded as second information in the waypoint information, or may not be recorded as second information (i.e., necessary information may be acquired based on sensor data, separately from second information). Hereinafter, along with specific examples of the termination condition, example processes to be performed by the controller 180 will be described. Any one or more of the following specific examples may be used in combination.

For example, the termination condition may include “the speed of the work vehicle 100 being greater than a predetermined value”. If the speed of the work vehicle 100 is too fast, it may not be reproduced during the travel via self-driving that is performed in the reproducing mode, or it may not be favorable for reproduction in the reproducing mode. Reproducibility of operations of the work vehicle 100 under the reproducing mode can be enhanced, by terminating recording of multiple pieces of waypoint information if the speed of the work vehicle 100 is too fast. As has been described with reference to FIG. 10, in the recording mode, based on sensor data that is output from a vehicle speed sensor such as the axle sensor 156 and/or the gear ratio sensor 159 that detects information of the gear ratio of the transmission 103, the controller 180 acquires any one or more of: information of the speed of the work vehicle 100, information of the engine speed of the work vehicle 100, and information of the gear ratio of the transmission 103. The controller 180 may acquire information of the speed of the work vehicle 100 based on sensor data that is output from the IMU 115. Based on the acquired information, the controller 180 determines whether the speed of the work vehicle 100 is greater than a predetermined value or not. The controller 180 may acquire information of the speed of the work vehicle 100 by acquiring information of the rate of change in the position of the work vehicle 100 per unit time, based on position data that is output from the positioning device 110. The condition that the speed of the work vehicle 100 is greater than a predetermined value may be expressed as the rate of change in the position of the work vehicle 100 per unit time being greater than a predetermined value.

The termination condition may include “the acceleration of the work vehicle 100 being greater than a predetermined value”. Acceleration is a rate of change in velocity per unit time. When the work vehicle 100 undergoes a sudden acceleration, a sudden deceleration (e.g., sudden braking), or the like, it may not be reproduced during the travel via self-driving that is performed in the reproducing mode, or it may not be favorable for reproduction in the reproducing mode. Therefore, reproducibility of operations of the work vehicle 100 under the reproducing mode can be enhanced, by terminating recording of multiple pieces of waypoint information if such excessive acceleration of the work vehicle 100 is detected. As in the case of (1) above, based on sensor data that is output from a vehicle speed sensor such as the axle sensor 156, the gear ratio sensor 159 that detects information of the gear ratio of the transmission 103, and/or the IMU 115, the controller 180 acquires any one or more of: information of the velocity of the work vehicle 100, information of the acceleration of the work vehicle 100, information of the engine speed of the work vehicle 100, and information of the gear ratio of the transmission 103. Based on the acquired information, the controller 180 determines whether the speed of the work vehicle 100 is greater than a predetermined value or not.

The termination condition may include “the angle of tilt of the work vehicle 100 being greater than a predetermined value” and/or “the rate of change in the angle of tilt of the work vehicle 100 per unit time being greater than a predetermined value”. A state where the angle of tilt of the work vehicle 100 or the rate of change thereof is too large is not favorable for reproduction in the reproducing mode. Reproducibility of operations of the work vehicle 100 under the reproducing mode can be enhanced, by terminating recording of multiple pieces of waypoint information when the angle of tilt of the work vehicle 100 or the rate of change thereof is too large. Based on sensor data that is output from the IMU 115, the controller 180 acquires information of the attitude of the work vehicle 100, and based on the acquired information, determines whether the angle of tilt of the work vehicle 100 and/or the rate of change thereof per unit time is greater than the predetermined value(s) or not.

The termination condition may include “the steering angle of the wheels responsible for steering of the work vehicle 100 being greater than a predetermined value” and/or “the rate of change in the steering angle of the wheels responsible for steering of the work vehicle 100 per unit time being greater than a predetermined value”. An excessive steering angle would correspond to the steering wheel being turned widely, and an excessive rate of change in the steering angle would correspond to the steering wheel undergoing a sudden operation. These states are not favorable for reproduction in the reproducing mode. Therefore, reproducibility of operations of the work vehicle 100 under the reproducing mode can be enhanced, by terminating recording of multiple pieces of waypoint information when such states are detected. As has been described with reference to FIG. 10, in the recording mode, based on sensor data (measurement value(s)) that is output from the steering wheel sensor 152 and/or the angle-of-turn sensor 154, the controller 180 acquires information of the steering angle of the wheels responsible for steering of the work vehicle 100, and based on the acquired information, determines whether the steering angle of the wheels responsible for steering of the work vehicle 100 and/or the rate of change thereof per unit time is greater than the predetermined value(s) or not.

The termination condition may include “there being less than a predetermined amount of fuel in the work vehicle 100”, “the battery voltage of the work vehicle 100 being lower than a lower than a predetermined value”, and/or “a problem of the work vehicle 100 being detected”. Such states are unsuitable for the travel for recording multiple pieces of waypoint information. The controller 180 acquires information of a remaining amount of fuel from the sensor data that is output from the fuel sensor, and based on the acquired information, determines whether the amount of fuel in the work vehicle 100 is smaller than the predetermined amount or not. From the sensor data that is output from the battery voltage sensor, the controller 180 acquires information of the battery voltage, and based on the acquired information, determines whether the battery voltage of the work vehicle 100 is lower than the predetermined value or not. Based on sensor data that is output from the sensor group 150, the controller 180 may detect other problems (i.e., states that are deemed as abnormal for the work vehicle 100).

The termination condition may include “a reception impediment of satellite signals existing at the positioning device 110”. What is meant by “a reception impediment of satellite signals” is a state where the reception of satellite signals has deteriorated so much that the reliability of positioning is lower than in a normal state. In such a state, the position data that is output from the positioning device 110 may be of poorer reliability, which is unsuitable for the travel for recording multiple pieces of waypoint information. A reception impediment may occur, for example, when the number of detected satellites is small (e.g., 3 or less), when the reception intensity of each satellite signal is low, or when multipath is occurring. The controller 180 can determine whether a reception impediment exists or not based on information concerning satellites that is included in GNSS data, for example. For instance, the presence or absence of a reception impediment can be determined based on the value of reception intensity for each satellite that is included in the GNSS data, or DOP (Dilution of Precision) values that indicate a deployment of satellites.

The termination condition may include “it being detected that the driver's seat of the work vehicle 100 is vacant”. When the driver is temporarily away from the driver's seat 107 (see FIG. 1) of the work vehicle 100, or is not properly seated in the driver's seat 107, recording of multiple pieces of waypoint information is terminated. For example, in the recording mode, this termination condition may be applicable while manual traveling is being performed via manual operation of the driver on the work vehicle 100. The termination condition may be applicable when, in the recording mode, performing self-traveling but partly traveling via manual operation of the driver on the work vehicle 100. Based on sensor data that is output from a seat switch mounted on the driver's seat 107 of the work vehicle 100, the controller 180 determines whether the driver's seat 107 is vacant or not. By detecting a load on the sitting surface of the driver's seat 107, the seat switch can detect whether the driver's seat 107 is vacant or not.

The termination condition may include “slipping of the wheels of the work vehicle 100 being detected” and/or “dashing of the work vehicle 100 being detected”. Slipping and dashing are not favorable for reproduction in the reproducing mode. Dashing is a phenomenon that may occur when a rotary tiller is linked as the implement 300 to the work vehicle 100, where tilling claws of the rotary tiller come in contact with the hard ground surface and fail to dig deeply into the earth, such that rotation of the tilling claws cause the work vehicle 100 to be suddenly thrusted forward. Based on sensor data that is output from a vehicle speed sensor such as the axle sensor 156 and the IMU 115, the controller 180 can acquire information of the speed of the work vehicle 100 and information of the acceleration of the work vehicle 100, and based on the acquired information, detect slipping or dashing of the work vehicle 100.

The termination condition may include “the traveling mode of the work vehicle 100 having been switched to a traveling mode that is incompatible with self-driving” and/or “the transmission 103 of the work vehicle 100 having been switched to a gear stage that is incompatible with self-driving”. These conditions may be applicable when manual traveling is being performed in the recording mode. For example, let it be assumed that the traveling mode of the work vehicle 100 has a four-wheel drive mode and a two-wheel drive mode, such that the four-wheel drive mode is compatible with self-driving but that the two-wheel drive mode is incompatible with self-driving; when a change from the four-wheel drive mode to the two-wheel drive mode is made in the recording mode, the controller 180 terminates recording of multiple pieces of waypoint information. In another case, where backward travel of the work vehicle 100 is incompatible with self-driving, the controller 180 terminates recording of multiple pieces of waypoint information if a change from the forward travel to the backward travel is made in the recording mode. Also, the controller 180 terminates recording of multiple pieces of waypoint information when a switching is made to a gear stage that is incompatible with self-driving among the plurality of gear stages of the transmission 103. For example, the controller 180 may acquire information concerning the traveling mode of the work vehicle 100 from the transmission 103, and based on the acquired information, detect a switching to a traveling mode that is incompatible with self-driving or a switching to a gear stage that is incompatible with self-driving among the plurality of gear stages of the transmission 103.

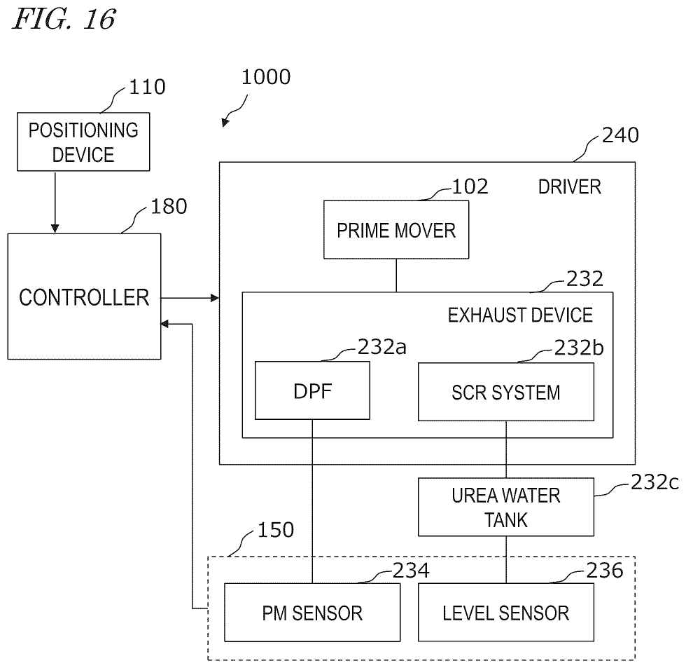

The termination condition may include “a predetermined condition concerning DPF regeneration in the work vehicle 100 being satisfied”. For example, as will be described below, it may include “the amount of particulate matter having been captured by the DPF 232a of the work vehicle 100 being greater than a predetermined value”. With reference to FIG. 16, an example processing to be performed by the controller 180 will be described.

As shown in FIG. 16, the work vehicle 100 includes an exhaust device 232 to effect discharging of the exhaust gas in the prime mover 102 (e.g., a diesel engine) to the outside. The exhaust device 232 includes a DPF 232a to capture particulate matter (PM) within the exhaust gas. When the amount of particulate matter captured in the DPF 232a becomes equal to or greater than a certain amount, “DPF regeneration” is performed to reduce the particulate matter in the DPF 232a and restore its capture capacity. For example, the particulate matter in the DPF 232a can be reduced by heating the exhaust gas from the engine 102 to a high temperature, or by mixing fuel with the exhaust gas. The controller 180 acquires information of the amount of particulate matter captured by the DPF 232a, based on sensor data that is output from a PM sensor 234 which detects the amount of particulate matter captured in the DPF 232a.

The termination condition may include “an abnormality of an SCR system in the exhaust device 232 of the work vehicle 100 being detected”. As shown in FIG. 16, a nitrogen oxide reducer 232b to reduce nitrogen oxides (NOₓ) within the exhaust gas is further provided in the exhaust device 232. The nitrogen oxide reducer 232b, which is also referred to as an SCR (Selective Catalytic Reduction) system 232b, reduces nitrogen oxides by using urea water as a reducing agent. The controller 180 can detect abnormalities of the SCR system 232b. For example, it can detect the remaining amount of urea water being too little, the urea water being frozen, impurities being included in the urea water etc., based on data that is output from a sensor (e.g., a level sensor 236) mounted in the urea water tank 232c.

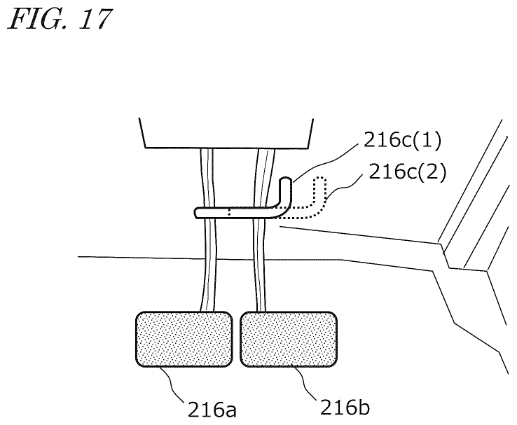

The termination condition may include “linkage between two brake pedals of the work vehicle 100 being released”. FIG. 17 is a diagram showing an example of braking operation devices 216 provided inside the cabin 105 of the work vehicle 100. As shown in FIG. 17, the work vehicle 100 includes two brake pedals 216a and 216b. With use of a link element 216c, the two brake pedals 216a and 216b are switched between a linked state and an unlinked state. In the figure, the position of the link element 216c in a linked state of the two brake pedals 216a and 216b is shown by a solid line, with “(1)” being added at the end of the reference numeral of the link element 216c. The position of the link element 216c in an unlinked state of the two brake pedals 216a and 216b is shown by a dotted line, with “(2)” being added at the end of the reference numeral of the link element 216c.

In an unlinked state, the two brake pedals 216a and 216b can independently operate braking controllers to control the axles for rotating the left and right rear wheels 104R. In a case where control under the reproducing mode is not compatible with operations in an unlinked state of the two brake pedals 216a and 216b, recording of multiple pieces of waypoint information may be terminated if the two brake pedals 216a and 216b enter an unlinked state. Based on data that is output from a sensor to detect the position of the link element 216c, the controller 180 can detect an unlinked state of the two brake pedals 216a and 216b.

The termination condition may include “the time and/or distance traveled while recording multiple pieces of waypoint information being greater than a predetermined value(s)” and/or “the data amount of multiple pieces of waypoint information recorded in the storage device 870 being greater than a predetermined value”. Based on information concerning the data amount of multiple pieces of waypoint information stored in the storage device 870 as acquired from the storage device 870, the controller 180 determines whether the aforementioned termination condition is met or not.

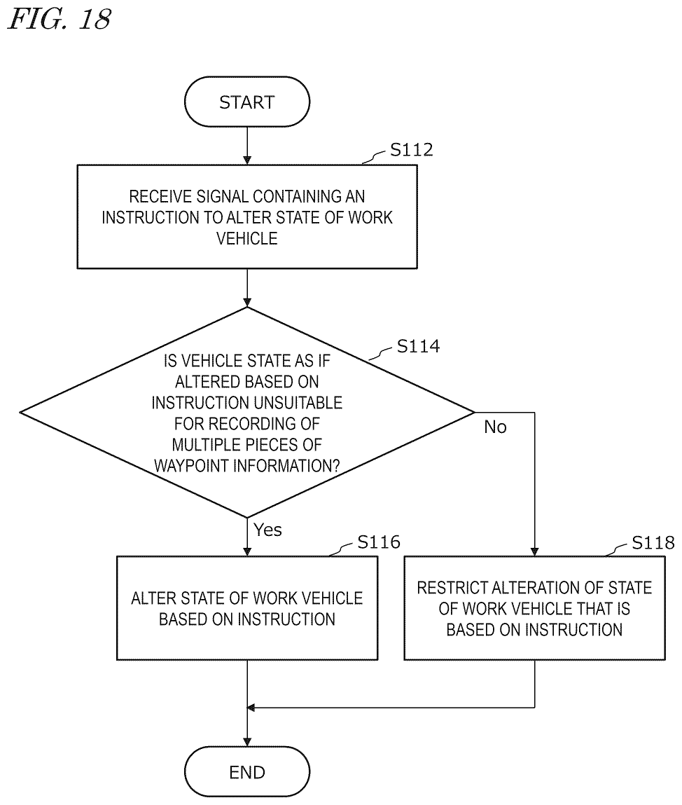

As in the example shown in FIG. 14, if recording of multiple pieces of waypoint information is terminated in the middle of the recording mode, it may become necessary to start traveling in the recording mode all over again in order to record multiple pieces of waypoint information. In the example of FIG. 18, on the other hand, termination of the recording of multiple pieces of waypoint information in the recording mode can be suppressed. FIG. 18 is a flowchart showing an example processing to be performed by the controller 180 when the user (e.g., driver) has performed an operation to alter the state of the work vehicle 100 in the recording mode. The processing of the flowchart of FIG. 18 may be performed at any timing during the recording mode, e.g., in combination with any of the aforementioned example flowcharts for use in the recording mode.

In the recording mode, at step S112, the controller 180 receives a signal including an instruction to alter the state of the work vehicle 100. When the user (e.g., driver) has performed an operation to alter the state of the work vehicle 100, in response to the user's operation, a signal including an instruction to alter the state of the work vehicle 100 is transmitted to the controller 180.

At step S114, the controller 180 determines whether the state of the work vehicle 100 as if it had been altered based on the instruction received at step S112 (which hereinafter may be referred to as an “assumed alternative vehicle state”) would present a state that is suitable for recording multiple pieces of waypoint information or not. The determination of step S114 is to be performed before the state of the work vehicle 100 is actually altered based on the received instruction.

The determination as to whether the assumed alternative vehicle state presents a state that is suitable for recording multiple pieces of waypoint information or not is made by determining whether the assumed alternative vehicle state satisfies a predetermined termination condition, for example. For instance, if the assumed alternative vehicle state satisfies the termination condition, the controller 180 determines that the assumed alternative vehicle state presents a state that is unsuitable for recording multiple pieces of waypoint information, and, if the assumed alternative vehicle state does not satisfy the termination condition, determines that the assumed alternative vehicle state presents a state that is suitable for recording multiple pieces of waypoint information. As the termination condition, the aforementioned termination conditions can be used. Typically, among the termination conditions (1) to (12) as exemplified above, any condition that may become satisfied as a result of the state of the work vehicle 100 being altered in response to the user's operation is applied. The controller 180 acquires information that is necessary for the determination in a similar manner to the above-described method, and based on the acquired information, determines whether the termination condition is satisfied or not.

At step S114, if it is determined that the assumed alternative vehicle state presents a state that is suitable for recording multiple pieces of waypoint information (“Yes” from step S114), then at step S116, the controller 180 alters the state of the work vehicle 100 based on the instruction received at step S112.

If step S114 finds that the assumed alternative vehicle state presents a state that is unsuitable for recording multiple pieces of waypoint information (“No” from step S114), then at step S118, the controller 180 restricts an alteration of the state of the work vehicle 100 that is based on the instruction received at step S112. That the controller 180 “restricts an alteration of the state of the work vehicle 100” encompasses not only inhibiting alteration of the state of the work vehicle 100 altogether, i.e., maintaining the state of the work vehicle 100 with no alteration at all, but also altering the state of the work vehicle 100 by allowing the received instruction to be reflected to an extent that the termination condition is not satisfied. For example, in a case where the termination condition includes the speed of the work vehicle 100 being greater than a predetermined value (e.g., 10 km/h), if an instruction that was received when the speed of the work vehicle 100 was 5 km/h included an instruction to alter the speed of the work vehicle 100 to 20 km/h, then the controller 180 may maintain the speed of the work vehicle 100 without altering it from the current speed (5 km/h), or alter it so that the speed of the work vehicle 100 will be equal to or less than the predetermined value (i.e., to 10 km/h or less in this example).

In the example of FIG. 18, if the user has performed an operation to alter the state of the work vehicle 100 in the recording mode, the controller 180 may restrict an alteration of the vehicle state that is based on the user's operation in such a manner that the altered state of the work vehicle 100 will remain suitable for recording of multiple pieces of waypoint information. Therefore, reproducibility of operations of the work vehicle 100 under the reproducing mode can be enhanced, and not only is it possible to smoothly perform self-traveling of the work vehicle 100 in the reproducing mode, but it is also possible to reduce the possibility that recording of multiple pieces of waypoint information may become terminated in the middle of the recording mode. This adds to the user's convenience because this can solve the problem associated with the need to start traveling in the recording mode all over again if recording of multiple pieces of waypoint information is terminated in the middle of the recording mode.

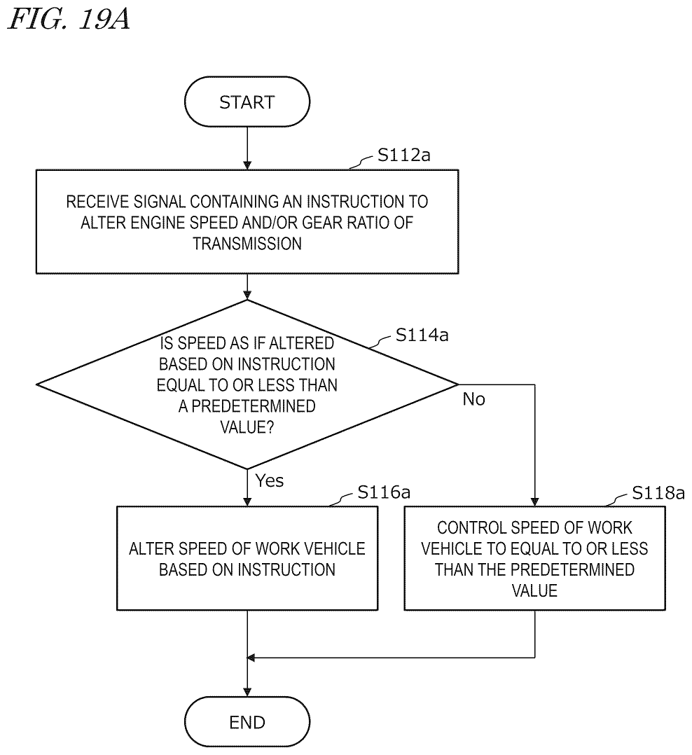

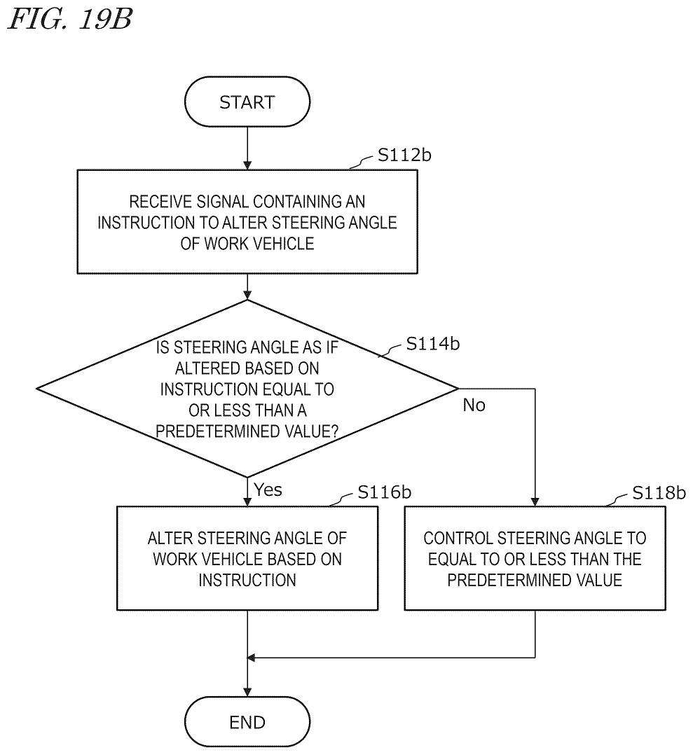

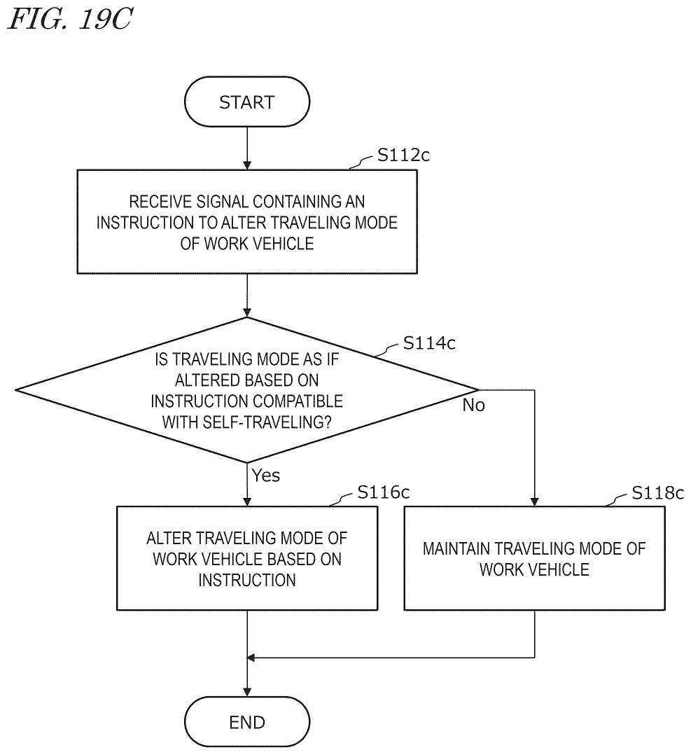

With reference to FIG. 19A to FIG. 19C, specific examples of the flowchart of FIG. 18 will be described. FIG. 19A to FIG. 19C are flowcharts each showing an example processing to be performed by the controller 180 when the user (e.g., driver) has performed an operation to alter the state of the work vehicle 100 in the recording mode.

As shown in FIG. 19A, in the recording mode, at step S112a, the controller 180 receives a signal including an instruction to alter the engine speed of the work vehicle 100 and/or the gear ratio of the transmission 103. When the user (e.g., driver) has performed an operation to alter the speed of the work vehicle 100, in response to the user's operation, a signal including an instruction to alter the engine speed of the work vehicle 100 and/or the gear ratio of the transmission 103 is transmitted to the controller 180.

At step S114a, the controller 180 determines whether the speed of the work vehicle 100 as if it had been altered based on the instruction received at step S112a (which hereinafter may be referred to as an “assumed alternative speed”) would present a state that is suitable for recording multiple pieces of waypoint information or not. The determination of step S114a is to be performed before the speed of the work vehicle 100 is actually altered based on the received instruction. The determination as to whether the assumed alternative speed presents a state that is suitable for recording multiple pieces of waypoint information is made by determining whether the assumed alternative speed satisfies the termination condition, for example. In this example, the termination condition includes the speed of the work vehicle 100 being greater than a predetermined value. Therefore, at step S114a, the controller 180 determines whether or not the assumed alternative speed is equal to or less than the predetermined value.

If step S114a finds that the assumed alternative speed is equal to or less than the predetermined value (“Yes” from step S114a), then at step S116a, the controller 180 alters the engine speed of the work vehicle 100 and/or the gear ratio of the transmission 103 based on the instruction received at step S112a to alter the speed of the work vehicle 100.

If step S114a finds that the assumed alternative speed is greater than the predetermined value (“No” from step S114a), then at step S118a, the controller 180 restricts an alteration of the speed of the work vehicle 100 that is based on the instruction received at step S112a. Herein, the controller 180 controls the speed of the work vehicle 100 to be equal to or less than the predetermined value. For example, the controller 180 may maintain the speed of the work vehicle 100 without altering it, or alter the speed of the work vehicle 100 so that it remains equal to or less than the predetermined value.

In the example of FIG. 19B, in the recording mode, at step S112b, the controller 180 receives a signal including an instruction to alter the steering angle of the wheels responsible for steering of the work vehicle 100. When the user (e.g., driver) has performed an operation to alter the steering angle of the wheels responsible for steering of the work vehicle 100, in response to the user's operation, a signal including an instruction to alter the steering angle of the wheels responsible for steering of the work vehicle 100 is transmitted to the controller 180.

At step S114b, the controller 180 determines whether the steering angle of the wheels responsible for steering of the work vehicle 100 as if it had been altered based on the instruction received at step S112b (which hereinafter may be referred to as an “assumed alternative steering angle”) would present a state that is suitable for recording multiple pieces of waypoint information or no. The determination of step S114b is to be performed before the steering angle of the work vehicle 100 is actually altered based on the received instruction. The determination as to whether the assumed alternative steering angle presents a state that is suitable for recording multiple pieces of waypoint information is made by determining whether the assumed alternative steering angle satisfies the termination condition, for example. In this example, the termination condition includes the steering angle of the wheels responsible for steering of the work vehicle 100 being greater than a predetermined value. Therefore, at step S114b, the controller 180 determines whether or not the assumed alternative steering angle is equal to or less than the predetermined value. Note that the termination condition may further include the rate of change in the steering angle of the wheels responsible for steering of the work vehicle 100 per unit time being greater than a predetermined value. In that case, too, the following process may be similarly performed.

If step S114b finds that the assumed alternative steering angle is equal to or less than the predetermined value (“Yes” from step S114b), then at step S116b, the controller 180 alters the steering angle of the wheels responsible for steering of the work vehicle 100 based on the instruction received at step S112b.

If step S114b finds that the assumed alternative steering angle is greater than the predetermined value (“No” from step S114b), then at step S118b, the controller 180 restricts an alteration of the steering angle of the work vehicle 100 that is based on the instruction received at step S112b. Herein, the controller 180 controls the steering angle of the work vehicle 100 to be equal to or less than the predetermined value. For example, the controller 180 may maintain the steering angle of the work vehicle 100 without altering it, or alter the steering angle of the work vehicle 100 so that it remains equal to or less than the predetermined value.

In the example of FIG. 19C, in the recording mode, at step S112c, the controller 180 receives a signal including an instruction to alter the traveling mode of the work vehicle 100. When the user (e.g., driver) has performed an operation to alter the traveling mode of the work vehicle 100, in response to the user's operation, a signal including an instruction to alter the traveling mode of the work vehicle 100 is transmitted to the controller 180.

At step S114c, the controller 180 determines whether the traveling mode of the work vehicle 100 as if it had been altered based on the instruction received at step S112c (which hereinafter may be referred to as an “assumed alternative traveling mode”) would present a state that is suitable for recording multiple pieces of waypoint information or not. The determination of step S114c is to be performed before the traveling mode of the work vehicle 100 is actually altered based on the received instruction. The determination as to whether the assumed alternative traveling mode presents a state that is suitable for recording multiple pieces of waypoint information is made by determining whether the assumed alternative traveling mode satisfies the termination condition, for example. In this example, the termination condition includes the traveling mode of the work vehicle 100 having been switched to a traveling mode that is incompatible with self-driving. Therefore, at step S114c, the controller 180 determines whether the assumed alternative traveling mode is compatible with self-driving or not.

If step S114c finds that the assumed alternative traveling mode is compatible with self-driving (“Yes” from step S114c), then at step S116c, the controller 180 alters the traveling mode of the work vehicle 100 based on the instruction received at step S112c. For example, let it be assumed that the traveling mode of the work vehicle 100 has a four-wheel drive mode and a two-wheel drive mode, such that the four-wheel drive mode is compatible with self-driving but that the two-wheel drive mode is incompatible with self-driving. When the controller 180 receives an in the recording mode, an instruction to alter from the two-wheel drive mode to the four-wheel drive mode, the controller 180 alters the traveling mode of the work vehicle 100 from the two-wheel drive mode to the four-wheel drive mode.

If step S114c finds that the assumed alternative traveling mode is incompatible with self-driving (“No” from step S114c), then at step S118c, the controller 180 inhibits an alteration of the traveling mode of the work vehicle 100 that is based on the instruction received at step S112b. In other words, the controller 180 maintains the traveling mode of the work vehicle 100. For example, let it be assumed that the traveling mode of the work vehicle 100 has a four-wheel drive mode and a two-wheel drive mode, such that the four-wheel drive mode is compatible with self-driving but that the two-wheel drive mode is incompatible with self-driving; when the controller 180 receives an instruction to alter from the four-wheel drive mode to the two-wheel drive mode in the recording mode, the controller 180 maintains the traveling mode of the work vehicle 100 at the four-wheel drive mode.

The processing to be performed by the controller of the travel control system according to an example embodiment of the present disclosure is not limited to the specific examples described above. For example, the aforementioned termination conditions are only examples, and other conditions may also be applicable.

The travel control systems according to the above example embodiments may be mounted to work vehicles lacking such functionality as an add-on. Such a control system may be manufactured and marketed independently from the work vehicle. A computer program for use in such a control system may also be manufactured and marketed independently from the work vehicle. The computer program may be provided in a form stored in a computer-readable, non-transitory storage medium, for example. The computer program may also be provided through downloading via telecommunication lines (e.g., the Internet).

Example embodiments according to the present disclosure are broadly applicable to various kinds of work vehicles for use in smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A travel control system for a work vehicle, comprising:
a positioning device to detect a position of the work vehicle and output position data;
one or more sensors to detect a state of the work vehicle and output sensor data; and
a controller configured or programmed to:
control operation of the work vehicle;
operate in a recording mode and a reproducing mode;
in the recording mode, record to a storage device multiple pieces of waypoint information based on the position data and the sensor data while the work vehicle is traveling, each of the multiple pieces of waypoint information including first information concerning the position of the work vehicle and second information concerning the state of the work vehicle;
in the reproducing mode, control the operation of the work vehicle while causing the work vehicle to travel via self-driving based on the first information and the second information included in the multiple pieces of waypoint information recorded in the recording mode; and
in response to a user operation while in the recording mode to make an alteration to the state of the work vehicle to produce an altered state, restrict the alteration that is based on the user operation when the altered state is unsuitable for recording of the multiple pieces of waypoint information.

2. The travel control system of claim 1, wherein the controller is configured or programmed to restrict the alteration that is based on the user operation when the altered state would satisfy a predetermined termination condition.

3. The travel control system of claim 2, wherein
the predetermined termination condition includes:
a speed of the work vehicle being greater than a predetermined value; or
an acceleration of the work vehicle being greater than a predetermined value; wherein
the controller is configured or programmed to, in response to the user operation while in the recording mode to make an alteration to an engine speed and/or a gear ratio of a transmission of the work vehicle to produce the altered state, restrict the alteration to the engine speed and/or the gear ratio of the transmission of the work vehicle when the speed or the acceleration of the altered state of the work vehicle would be greater than the predetermined value.

4. The travel control system of claim 3, wherein
the predetermined termination condition includes the speed of the work vehicle being greater than a first value; and
the controller is configured or programmed to, in response to the user operation, control the speed of the work vehicle to be equal to the first value or below.

5. The travel control system of claim 4, wherein the controller is configured or programmed to:
cause the first value to vary depending on an angle of tilt of the work vehicle; and
decrease the first value as the angle of tilt of the work vehicle increases.

6. The travel control system of claim 2, wherein
the predetermined termination condition includes a traveling mode of the work vehicle having been altered to a mode that is incompatible with self-driving of the work vehicle; and
the controller is configured or programmed to, in response to the user operation made in the recording mode to make an alteration of the traveling mode to produce the altered state, maintain the traveling mode when the traveling mode of the altered state produced by the alteration based on the user operation is incompatible with self-driving.

7. The travel control system of claim 6, wherein the controller is configured or programmed to, when a user operation to alter the traveling mode from a four-wheel drive mode to a two-wheel drive mode is made in the recording mode, maintain the four-wheel drive mode.

8. The travel control system of claim 2, wherein
the predetermined termination condition includes:
a steering angle of wheels responsible for steering of the work vehicle being greater than a predetermined value; or
a rate of change in a steering angle per unit time being greater than a predetermined value; and
the controller is configured or programmed to, in response to the user operation while in the recording mode to make an alteration of the steering angle to produce the altered state, restrict the alteration of the steering angle when the steering angle or a rate of change in the steering angle per unit time of the altered state produced by the alteration of the steering angle would be greater than the predetermined value.

9. The travel control system of claim 2, wherein the predetermined termination condition includes:
a speed of the work vehicle being greater than a predetermined value;
an acceleration of the work vehicle being greater than a predetermined value;
a steering angle of wheels responsible for steering of the work vehicle being greater than a predetermined value;
a rate of change in the steering angle per unit time being greater than a predetermined value;
an angle of tilt of the work vehicle being greater than a predetermined value; or
a change to a traveling mode that is incompatible with self-driving of the work vehicle having been made.

10. The travel control system of claim 1, wherein the controller is configured or programmed to, when restricting the alteration that is based on the user operation in the recording mode, cause a display device of the work vehicle to display an indication notifying a user that the alteration that is based on the user operation is restricted.

11. The travel control system of claim 1, wherein the second information includes at least one of information of a velocity of the work vehicle, information of a gear ratio of a transmission of the work vehicle, information of an engine speed of the work vehicle, or information of an attitude of the work vehicle.

12. The travel control system of claim 1, wherein
an implement is linked to the work vehicle; and
the second information includes information concerning operation of the implement; and
the controller is configured or programmed to, in the reproducing mode, control the operation of the implement based on the second information included in the multiple pieces of waypoint information recorded in the recording mode.

13. The travel control system of claim 12, wherein, in the recording mode, the work vehicle is configured or programmed to travel while performing a task using the implement.

14. The travel control system of claim 12, wherein, in the recording mode, the work vehicle is configured or programmed to travel among a plurality of crop rows while performing a task using the implement.

15. The travel control system of claim 12, wherein
the work vehicle includes a linkage device to which the implement is connected; and
the second information includes information concerning a state of the linkage device.

16. The travel control system of claim 15, wherein
the linkage device includes a three-point hitch to adjust a height of the implement; and
the information concerning the state of the linkage device includes information of a height of the three-point hitch.

17. The travel control system of claim 15, wherein,
the linkage device includes a PTO shaft to supply motive power to the implement; and
the information concerning the state of the linkage device includes information of rotation ON or OFF of the PTO shaft.

18. A work vehicle comprising:
the travel control system of claim 1;
a travel device including wheels responsible for steering; and
a first driver to drive the travel device; wherein
in the reproducing mode, the controller is configured or programmed to cause the work vehicle to travel via self-driving by controlling the first driver based on the first information and the second information included in the multiple pieces of waypoint information recorded in the recording mode.

19. The work vehicle of claim 18, further comprising:
an implement linked to the work vehicle; and
a second driver to drive the implement; wherein
the second information includes information concerning operation of the implement; and
in the reproducing mode, the controller is configured or programmed to control the operation of the implement by controlling the second driver based on the second information included in the multiple pieces of waypoint information recorded in the recording mode.

20. A method of travel control for a work vehicle to be performed by a controller configured or programmed to control operation of a work vehicle and operate in a recording mode and a reproducing mode, the method comprising:
in the recording mode, while the work vehicle is traveling, recording to a storage device multiple pieces of waypoint information based on position data acquired from a positioning device to detect a position of the work vehicle and sensor data acquired from one or more sensors to detect a state of the work vehicle, each of the multiple pieces of waypoint information including first information concerning the position of the work vehicle and second information concerning the state of the work vehicle;
in the reproducing mode, controlling the operation of the work vehicle while causing the work vehicle to travel via self-driving based on the first information and the second information included in the multiple pieces of waypoint information recorded in the recording mode; and
in response to a user operation while in the recording mode to make an alteration to the state of the work vehicle to produce an altered state, restricting the alteration that is based on the user operation when the altered state is unsuitable for recording of the multiple pieces of waypoint information.
